(19) United States
(12) Patent Application Publication
(10) Pub. No.: US 2018/0047071 A1
(43) Pub. Date: Feb. 15, 2018

(54) SYSTEM AND METHODS FOR AGGREGATING PAST AND PREDICTING FUTURE PRODUCT RATINGS

(71) Applicant: eBay Inc., San Jose, CA (US)

(72) Inventors: David Wei Hsu, Decatur, GA (US); Hsu Han Ooi, Bellevue, WA (US); Samuel Schuler Clark, Seattle, WA (US); Stefan Schoenmackers, Albuquerque, NM (US); Igor Tatarinov, Shoreline, WA (US)

(21) Appl. No.: 15/788,273

(22) Filed: Oct. 19, 2017

Related U.S. Application Data
(63) Continuation of application No. 13/949,093, filed on Jul. 23, 2013.
(60) Provisional application No. 61/675,280, filed on Jul. 24, 2012.
(60) Provisional application No. 61/735,930, filed on Dec. 11, 2012.

(51) Int. Cl. G06Q 30/02

(52) U.S. Cl. CPC G06Q 30/0282

(57) ABSTRACT

Embodiments of the invention can be utilized in multiple ways to assist in generating “predictions” with regards to the expected ratings or rankings of products or services. These predictions can then be used to inform consumers which products or services are expected to be reliable, good values, etc. By using one or more machine learning processes that are trained using product and product review data, embodiments of the invention are able to generate predictions of expected ratings behavior for new products and/or similar products. Further, when the product and product review data is associated with a time at which the data was generated, embodiments of the invention are able to predict how a product or a product's features will be viewed in the future.

### CROSS REFERENCE TO RELATED APPLICATIONS

This application is a continuation of U.S. application Ser. No. 13/949,093, filed Jul. 23, 2013, which claims the benefit of priority of U.S. Provisional Application No. 61/675,280, filed Jul. 24, 2012, and U.S. Provisional Application No. 61/735,930, filed Dec. 11, 2012, each of which is hereby incorporated by reference in its entirety.

### BACKGROUND

Embodiments of the invention relate to systems, apparatuses, and the associated methods for providing consumers with information related to products, and more specifically, to methods of processing information related to online ratings and reviews of consumer products in order to provide consumers with more accurate and reliable product reviews, product ratings, and product ranking data.

When a consumer is considering the purchase of a new product or service (e.g., a television, camera, large appliance, etc.) it is not uncommon for them to want to find information about what others thought of the product or service. In response to that interest, consumers can visit a variety of online shopping sites or product review services to read user and expert reviews for products. These sites employ a variety of techniques for gathering, presenting, and in some cases processing the reviews to assist consumers in making purchase decisions. For example, some sites utilize “experts” that use and review the products, and then write reviews for their sites. Presumably these expert reviews have value because the authors are familiar with a range of similar or competing products, and therefore can provide more informative comparisons between products. Other sites or review services encourage consumers who purchased a product to write a review directly on the site. Still other sites may aggregate reviews from multiple sources, or based on their own product testing and/or other expert reviews, assign a quality score to the product.

While these types of sites or review aggregation services are intended to help consumers decide which product is “best” for them to buy, they do have limitations. For example, a review and its associate “score” is specific to the time it was written, making it difficult for consumers to determine if an older score is as relevant or meaningful at present. An expert can only manually create a review and/or score for a limited number of products, so sites that feature expert reviews tend to have limited product coverage. Further, experts tend to focus on the most popular products, making it challenging to find as reliable information for less popular products. Reviews provided by individual consumers (as well as other review sources) can have their own biases against certain manufacturers or product features, and this can have a negative impact on the reviews/scores they provide.

Some review sites do not create scores and/or recommendations based solely on user reviews (whether contributed by experts or consumers), leaving it to consumers to determine themselves whether or not they should buy a product. Further, review sites typically do not combine user and expert reviews together into a single score and/or recommendation, leaving it up to a consumer to evaluate the different reviews and the veracity of their respective sources, and then to make their own decision. Still further, most review sites or services do not do a reliable job of matching reviews to variants of a particular base product, which may cause a consumer to miss a relevant review for a product.

As recognized by the inventors, a fundamental problem that arises in helping consumers determine how to interpret reviews or other forms of product recommendations is that products are typically not ranked or evaluated in accordance with a standardized quality score or metric. For example, many review sites use their own review categories and/or ratings system to provide users with information about product quality. This can create a problem for consumers when comparing reviews posted by multiple sources, as there is no easy way to combine the separate scores (or the scores of both customers and experts) into a single meaningful value. Further, customer reviews and rankings can be “noisier” and display more variability when only a relatively small sample is considered, as would be the case for a recently released product. Thus, consumers would benefit from a single, aggregate review and common rating system for a product that takes into account user and expert reviews, and factors such as the recency of a review, product rating method, and product score based on a previous model in order to provide a data-driven, unbiased, and more useful product recommendation.

Another problem is that existing product ranking/scoring methods reflect past information. That is, they are based on events in the past regarding consumer evaluations and their satisfaction with products at the time of writing the review. This presents at least two issues. First, past information on customer satisfaction or the popularity of a product may not be indicative of future customer receptiveness to the product. For example, when a product first comes out, it may have an artificially low score due to the relatively small number of recent reviews compared to more mature products. Similarly, an initial set of reviews may be very positive, but as technology matures, a later consumer may not find a product to be as desirable.

The second issue is that there is no objective way to compare separate ranking methods in order to determine whether one method to rank or evaluate products is more accurate or more reliable than another. This makes the process of improving a product ranking/scoring method more difficult since there is no formal way to assess the accuracy or quality of the method before and after an adjustment is made to the relevant heuristic or algorithm.

Assessing the quality of product ranking methods has typically comprised ad-hoc evaluation by a small population (e.g., the developer of the method or developer plus colleagues), which leads to the potential for personal bias and the inability to evaluate more than a very small percentage of products. Larger scale evaluations may comprise A/B tests (a methodology of using randomized experiments with two variants, A and B, which are the control and treatment in a controlled experiment) on a live website that measure how a general population interacts with alternative ranking methods. However, it may take several weeks or longer to run an A/B experiment that has sufficient ability to discriminate between different ranking methods.

At present there is no formal way to frame the problem of product ranking that enables a relatively fast, systematic, and repeatable experimentation cycle, so that evaluation of alternative product ranking methods can be performed efficiently and relatively quickly. In addition, measuring the accuracy or reliability of a ranking system based only on currently available data may not adequately cover possible scenarios that would be desirable to test. For example, if it is desired to determine whether a ranking system is able to assess the quality of a product that was recently released, but that product differs significantly from products for which historical data is available, then there may be no effective way to include this scenario in an evaluation.

Embodiments of the invention are directed toward solving these and other problems individually and collectively.

### SUMMARY

Embodiments of the invention are directed to a system, apparatuses, and associated methods for processing information related to product ratings and reviews in order to provide consumers with an improved understanding of the relative benefits of different products. In one embodiment, the invention may be used to generate an aggregate score or rating based on processing and combining multiple reviews, where those reviews may be created by regular consumers, “experts”, or both. In another embodiment, the invention may be used to generate a “model” of the relationship between a product's reviews or ratings and its sales and consumer acceptance. Based on such a model, initial sales data may be used to generate an estimate or “prediction” of the ratings or reviews that a product would have been likely to receive when it was brought to market, but before the sales of the product were sufficient to result in the sales data used to develop the model. Thus, the model provides a way to link or couple expected initial reviews with later actual sales data.

As recognized by the inventors, one way to address the shortcomings of current approaches to generating reliable product reviews and ratings/rankings from multiple sources and timeframes is to explicitly state the problem of product ranking as one of “predicting” how popular and well received a product will be in the future. This solves one of the problems with current approaches, because instead of making the object of a product ranking to be a reflection of past customer response to a product, it explicitly sets the objective to be a reflection of future customer acceptance of a product. In particular, the product ranking/score at present for a product should reflect how many people are expected to buy the product in the future and how well they will rate the product. As one example, a new product that is expected to be very popular in the future should have a relatively high rank today even if this is not reflected in the number of people that have presently reviewed the product.

Casting product ranking/scoring as a prediction problem also provides a formal framework for automatically evaluating the quality (i.e., the accuracy or reliability) of a proposed product evaluation model. Given a historical stream of product ratings and reviews (i.e., associated with a time or timeframe of publication), the inventive method is able to determine a measure of the accuracy of product scores/rankings generated from reviews up to a certain point in time t₀, compared to a score/ranking based on reviews and ratings generated in the future with respect to t₀. This provides a way to “tune” or adapt how ratings or rankings are derived from sales data and review data (or from ratings or other types of data) over time as additional information about a product's acceptance becomes available. It also provides a formal mechanism for “predicting” future ratings/rankings based on relatively sparse initial data. Further, the ability to test the quality of product ratings based on past data also increases the number of potential scenarios that the testing procedure may cover since the method can be used to measure the quality of the generated ratings at multiple points in time instead of just at the present time.

While a hand-tuned formula for combining reviews and ratings may provide an adequate solution for generating an overall product rating, it may be desirable to create a more robust (and more accurate) product evaluation method by using additional sources of information. For example, in some cases certain expert reviewers are of higher quality (or reliability) than others and therefore it may be desirable that they contribute more to a product ranking. Other examples of information that may be desirable to include are time-series aggregates of review ratings or review volume, product features, product price histories, brand-level reputation, historical manufacturer reliability data, or information about prior products within the same model line. This may be useful because the additional information has the potential to improve the quality of a ranking/rating function, and may allow high quality rankings and ratings to be generated for products based on less or sparser review information (e.g., for products that haven't been released, or were recently released thru limited channels). Unfortunately, creating a useful overall rating/ranking formula manually from multiple sources of information is a very difficult task. This is because there may be a very large (in some cases an almost infinite) number of ways that different sources of information can be combined into a ranking/rating formula. However, as recognized by the inventors, formulating the rating/ranking problem as a prediction problem permits use of machine-learning algorithms to automatically generate a predictor from multiple information sources. As a result, given a history of product reviews, sales, and other information, one can train machine-learning models to “predict” a product rank/score that accurately reflects expected future popularity and customer satisfaction.

Note that while the reference to products herein may suggest that the invention is limited to use with hard-goods that are purchased by consumers, embodiments of the invention may also be applied to data concerning other domains where reviews and ratings are commonly generated and aggregated for the purpose of helping consumers choose between alternatives. For example, the inventive techniques can be applied to help consumers evaluate travel agencies, restaurants, hotels, or service providers among other sources of products and/or services.

In general, the techniques that are described herein can be applied to domains where it is possible to collect expert and/or user reviews and ratings, and the dates of the reviews/ratings for the entities involved (e.g., the products or service providers). For example, one can apply the techniques described herein to restaurant ratings or hotel ratings, since reviews and/or ratings for these products/services are widely available. With certain modifications (e.g., alternate formulas for aggregating information on purchases and/or reviews), the inventive concepts for automated evaluation of model quality and determining entity scoring/ranking via machine-learning may be applied to other domains where it is possible to measure one or more of purchases, popularity, and customer response.

In addition to creating a rating or ranking for a product based on aggregating reviews from one or more sources, it may also be useful to create ratings or rankings for specific aspects of products (such as design elements, operational qualities, uses, etc.) based on how reviewers discuss or refer to those aspects. This type of analysis may be performed via sentiment analysis techniques, and is used as part of some shopping sites. However, just as generating product ratings as an aggregation of past product ratings has weaknesses as an indicator of actual current product desirability, treating sentiment analysis as a task of aggregating past opinions about a product suffers from similar limitations. As recognized by the inventors, the concepts described herein regarding generating overall product ratings by predicting overall future customer satisfaction can also be applied to the task of sentiment analysis. For example, instead of directly reporting aggregates of sentiments expressed in past product reviews, the inventive techniques can be used to examine sentiment analysis as a problem of predicting how future reviewers will respond to specific aspects of a product.

In one embodiment, the invention is directed to a method of generating a rating for a product or service, where the method includes:

accessing data relevant to the product or service;

associating at least some portion of the accessed data with a time or date at which the data was valid;

using accessed data applicable to a first time or date as training data that is input to a machine learning process, where accessed data applicable to a second and later time or date is used as a target for the machine learning process, a result of the machine learning process being a model representing a relationship between the accessed data applicable at the first time or date and the accessed data applicable at the second time or date; and

using the model to generate the rating for the product or service by using data for the product or service as an input to the model;

using the model to generate an output of the model; and

deriving the rating for the product or service from the output of the model.

In another embodiment, the invention is directed to an apparatus for assisting a consumer to purchase a product or service by generating a rating for the product or service, where the apparatus includes:

an electronic processor programmed to execute a set of instructions, wherein when executed, the instructions cause the apparatus to perform a set of operations, the operations comprising
accessing data relevant to the product or service;
associating at least some portion of the accessed data with a time or date at which the data was valid;
using accessed data applicable to a first time or date as training data that is input to a machine learning process, where accessed data applicable to a second and later time or date is used as a target for the machine learning process, a result of the machine learning process being a model representing a relationship between the accessed data applicable at the first time or date and the accessed data applicable at the second time or date; and
using the model to generate the rating for the product or service by
   using data for the product or service as an input to the model;
   using the model to generate an output of the model; and
   deriving the rating for the product or service from the output of the model.

### BRIEF DESCRIPTION OF THE DRAWINGS

Illustrative embodiments of the present invention are described in detail below with reference to the following drawing figures:

FIG. 1 is a block diagram illustrating components or elements of a system in which an embodiment of the invention may be implemented;

FIG. 2 is a block diagram illustrating certain functional components or elements of an embodiment of the inventive Product Rating Aggregation and Prediction Service Platform depicted in FIG. 1;

FIG. 3 is a block diagram illustrating certain functional components or elements of an embodiment of the inventive rating generation system that operates to aggregate expert and user review information;

FIG. 4 is a block diagram illustrating certain functional components or elements of an embodiment of the inventive system for predicting aggregate review behavior based on future reviews and ratings;

FIG. 5 is a diagram illustrating a data model suitable for use in implementing an embodiment of the inventive product review aggregation service;

FIG. 6 is a diagram illustrating a data collection process suitable for use in implementing an embodiment of the inventive product review aggregation service;

FIG. 7 is a diagram illustrating a product or service clustering technique that may be used to implement an embodiment of the invention;

FIG. 8 is a flowchart or flow diagram illustrating an exemplary process for generating a base product's combined aggregate review score (CAR) from past user and/or expert reviews, and may be used to implement an embodiment of the invention;

FIG. 9 is a flow chart or flow diagram illustrating an example process for generating predictions of future product ratings that may be implemented in an embodiment of the invention;

FIGS. 10-13 are illustrative “screen shots” showing how features of an embodiment of the invention may be presented to a consumer;

FIG. 14 is a flow chart or flow diagram illustrating an exemplary process for generating expected review ratings and the quantity of such reviews, which may be implemented using the inventive processes and methods described herein; and

FIG. 15 is a block diagram illustrating example elements or components of a computing device or system 1500 that may be used to implement one or more of the methods, processes, functions or operations of an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described as being required.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will be thorough and complete, and will convey the scope of the invention to those skilled in the art.

Among other things, the present invention may be embodied in whole or in part as a system, as one or more methods, or as one or more devices. Embodiments of the invention may take the form of an entirely hardware implemented embodiment, an entirely software implemented embodiment or an embodiment combining software and hardware aspects. For example, in some embodiments, one or more of the operations, functions, processes, or methods described herein may be implemented by a suitable processing element (such as a processor, microprocessor, CPU, controller, etc.) that is programmed with a set of executable instructions (e.g., software instructions), where the instructions may be stored in a suitable data storage element. In some embodiments, one or more of the operations, functions, processes, or methods described herein may be implemented by a specialized from of hardware, such as a programmable gate array, application specific integrated circuit (ASIC), or the like. The following detailed description is, therefore, not to be taken in a limiting sense.

The systems, elements, components, processes, functions, methods, and operations described herein with reference to one or more embodiments of the invention can be utilized in multiple ways to assist in generating “predictions” with regards to the expected ratings or rankings of products or services. Product reviews and/or ratings from multiple sources may be combined to generate an aggregate opinion or rating of a product that is more robust than the rating from a single source. These aggregate ratings can then be used to inform consumers which products or services are expected to be reliable, good values, etc. Further, when the product data and/or product review data is associated with a time at which the data was generated or made publicly available, embodiments of the invention are able to predict how a product or a product's features will be viewed in the future. By using one or more machine learning models that are trained using product data (such as ratings, rankings, product specifications, manufacturer reputation, product model history, etc.) and/or product review data, embodiments of the invention are able to generate predictions of expected ratings behavior for new products and/or similar products.

Exemplary embodiments of the inventive system, apparatuses, and methods described herein address one or more of the previously stated limitations of conventional approaches to generating meaningful product or service ratings/rankings from multiple sources and with respect to multiple timeframes. In particular, embodiments of the invention address the following problems that arise from the limitations or constraints of conventional approaches:

a. Limited review coverage from expert sources—the invention includes provisions for collecting review content from multiple expert sources and user review sources to increase coverage and variety of review content;

b. Reviewers from different sources grade on different scales—the invention includes statistical techniques for capturing and normalizing the biases present in individual review sources so that the transformed review scores can be compared using a common scale;

c. Aggregating multiple review sources—the invention includes a process for normalizing review source ratings on a common scale to enable aggregation of reviews obtained from different sources into a single score;

d. In some cases review content may be associated with a subset of the available variants of the same base product—the invention includes a sub-process that enables grouping of products that are variants of, configuration changes to, or bundled options based on an underlying base product into a common entity for the purposes of evaluating product ratings (for example, different colors for a car seat or different RAM/hard drive options for a laptop may be treated as variants of a single base product). This enables the same content (or with minimal alterations) to be applied to multiple variants of a product and the same rating to apply across those variants;

e. Product ratings reflect past performance and do not necessarily provide insight into future performance—the invention includes a characterization of the product rating problem framed in terms of a prediction of a product rating that is based on future reviews and product information. In addition, embodiments of the invention include a process by which historical ratings and reviews can be collected and used to evaluate the accuracy of a candidate rating method or system and its ability to predict an idealized rating based on future reviews and product information (which may or may not include a rating or ranking);

f. Manual methods or A/B tests for evaluating solution quality are time-consuming and/or biased—the invention includes a process by which historical ratings and reviews can be used to evaluate solution quality. This reduces the need to rely on manually generated analysis or A/B tests for testing candidate solutions;

g. Manual combination of heterogeneous information to generate a candidate solution is slow, difficult, error prone, and may be impractical—the invention includes a machine learning framework that enables the generation of candidate solutions automatically from heterogeneous features; and

h. Additional benefits may be obtained by rating products along specific dimensions—the invention includes a predictive framework for performing sentiment analysis to generate predictions on how users will communicate about specific features of a product in the future.

In one embodiment of the inventive system and methods, product scores (e.g., ratings and/or rankings) and recommendations based on user and/or expert reviews are aggregated and provided to consumers, in order to better assist consumers in making purchasing decisions. In one implementation, credible sources of user and expert reviews are algorithmically identified and searched for relevant data. If structured data is available within a review (such as an expert enumerating a list of pros and cons of a particular product), then that information may be gathered.

In one embodiment, variants of a common base product are identified so that product rating and/or review information can be applied to multiple variants of the product (such as other versions that share the same basic platform or fundamental features). This ensures that the same computed rating or ranking is applied to the base product and to its variants.

In one embodiment, the quality (e.g., the reliability or accuracy) of a product rating system may be measured by comparing the generated rating based on information (such as reviews or rankings) obtained during one time period to the rating that would have been generated if the system had access to additional information about the product (such as sales numbers, revenues, and later reviews) from a later time period. This computation of the “quality” of a rating system or methodology may then be used to compare alternative ways of generating product ratings, to enable selecting the best rating algorithm for use in a particular situation or with a particular set of data. This capability can enable researchers and algorithm developers to evaluate the quality of their proposed solutions much more quickly than alternative approaches such as manual evaluation or website A/B tests, and as a result enables a much faster development cycle.

In one embodiment, a system/method of evaluating a rating method may use as inputs (1) a candidate algorithm to evaluate based on product information already known, (2) an “ideal” rating formula based on future ratings, and (3) ratings/reviews/product information and the time that the data was generated/published. The evaluation system may then operate by (a) for each product at different points in time, applying the candidate algorithm based on information known up to that point in time, (b) apply the ideal formula to all information known about the product including information that is published in the future with respect to the time in question, and (c) compare the candidate rating/ranking against the ideal rating/ranking and aggregate the comparisons to form a final indicator of rating method quality (e.g., accuracy, reliability, or another suitable metric).

Note that the choice of what quantity to generate for purposes of comparing the candidate rating methods and how to determine which method is “better” may be dependent on the product or service being evaluated and the goal of the evaluation. For example:

a. If the role of the system is to generate a real-valued signal informational display of future average product/service rating and counts, or an overall rating score that takes into account popularity and customer response, then a metric that looks at the error of the real-valued prediction compared to the target (e.g., least squared error) may be appropriate;

b. If the role of the system is to generate a ranking of products, then an information retrieval based ranking metric, such as NDCG may be appropriate; and

c. If the role of the system is to generate a set of top products irrespective of ranking, then an information retrieval based metric such as precision or recall of top scored products versus actual top products may be appropriate. In general, one should look at multiple metrics for error evaluation that are of the type of error metrics listed when evaluating the suitability of candidate methods or algorithms.

In accordance with the inventive methods and systems, machine learning techniques and methods can be used to generate a predictor of future aggregate product ratings from historical data on product sales, ratings, and reviews. Given a database of existing products, including data related to both externally generated product scores as well as structured product or product-related information (e.g., brand reputation, base model quality, base model and variant model features, average price level, etc.), a machine learning problem can be formulated to “predict” the expected future rating or rank of a product based on known information. This technique is also applicable in the case of a product having a relatively small number of reviews, but not enough to make a more certain prediction. In addition, a predicted score range (e.g., “this product is likely to have a ratings score in the range between 65 and 75”) can be generated in order to represent the uncertainty or range in the prediction.

One or more of the techniques described herein may be applied to a “domain” where reviews and ratings are generated by expert sources and/or by consumers. One or more of the methods, functions, processes, or operations described herein relating to combining expert and consumer review ratings may be applied to a domain where consumer reviews/ratings can be collected individually or in aggregate. The inventive techniques applicable to the discovery of related product variants that should generally share the same review content/ratings can be applied to a domain where this type of assumption is warranted, or where the same content covers related products or base product variants (that typically differ only with respect to minor features). The inventive systems and techniques related to evaluation (over a historical time series) of methodologies for generating reviews/ratings and the application of machine learning models to “predict” future aggregates of reviews/ratings can be applied across a domain where such data can be associated with the time when the content (i.e., the reviews, ratings, rankings, etc.) was created or published.

In general, while the specific embodiments of the invention described herein are associated with goods that may be purchased in a store or via a website, the inventive features may also be applied to domains such as restaurants, hotels, service providers (e.g., doctors, bankers, lawyers), schools, or other products or services that can be rated or compared (as long as the restrictions described previously are applicable). For example, one or more of the techniques described herein can be applied to generate restaurant ratings or hotel ratings, since reviews and/or ratings for these service providers are typically available. With certain modifications (e.g., alternate formulas for aggregating information on purchases and/or reviews), the inventive ideas for evaluation of methodology quality and determining product rating/ranking via machine learning can be applied to other domains where one can measure popularity and customer response via one or more metrics, such as sales rank, sales volume, or other popularity/quality related quantities or signals.

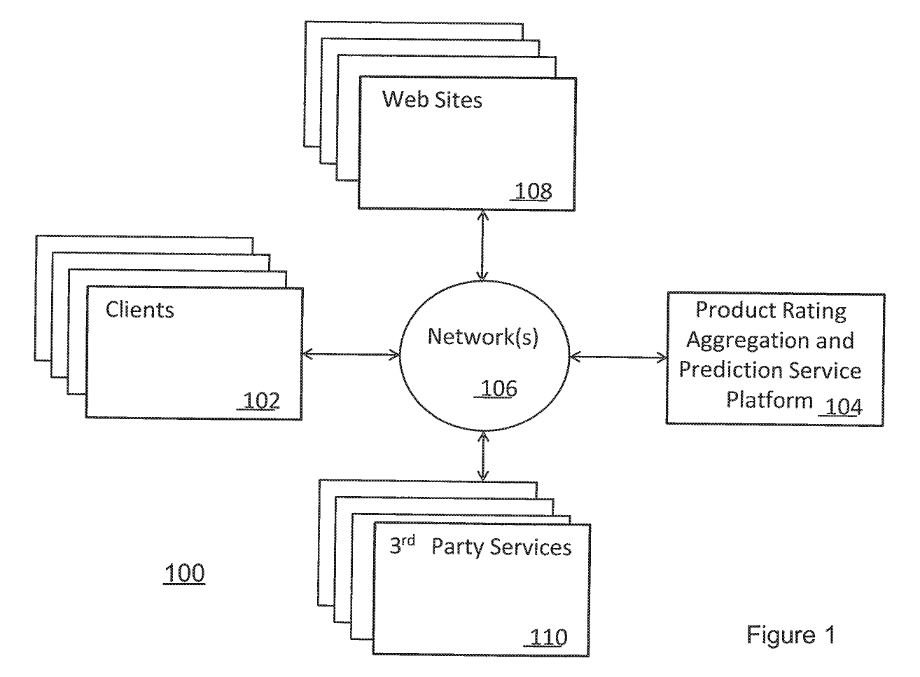

Embodiments of the invention may be implemented, at least in part, with one or more computing devices and/or computing device components, such as a server, CPU, processor, microprocessor, or controller that is suitably programmed to execute a set of software instructions. FIG. 1 is a block diagram illustrating components or elements of a system or environment 100 in which an embodiment of the invention may be implemented. The example system or environment 100 may include clients 102 capable of accessing a product rating aggregation and prediction service platform 104 through one or more suitable networks 106. For example, network(s) 106 may include a communication network and/or a computer network. Network(s) 106 may include a telephony network and/or a digital data network, including a public data network such as the Internet. Clients 102 may include any suitable type of client device and/or program capable of accessing the product rating platform 104, and may each incorporate and/or be incorporated by one or more computing devices. For example, the product rating platform 104 may incorporate a web-based rating service and clients 102 may correspond to web browsers capable of accessing the web-based rating service. Product rating aggregation and prediction service platform 104 may utilize any suitable web service protocol and/or component. In accordance with one embodiment of the invention, service 104 is, alternatively or in addition, an authentic deal identification service (which may operate to make consumers aware of “authentic deals”, i.e., products or services that are offered at a price that is not reflective of their relative value).

Example computing system or environment 100 may further include one or more web sites 108 and one or more third-party services 110. For example, web sites 108 may include one or more of manufacturer web sites, product review web sites, news web sites, and web log (“blog”) web sites. Third-party services 110 may include web-based services capable of providing data in a pre-defined format. For example, third-party services 110 may include user interfaces (such as application programming interfaces (APIs)) configured to provide product data collected and/or curated by third-party services 110. Note that the components, clients, networks, web sites and/or services 102-110 of system or environment 100 may each be implemented by one or more computers and/or with any suitable distributed computing technique (such as Software-as-a-Service, cloud-computing, web services, etc.).

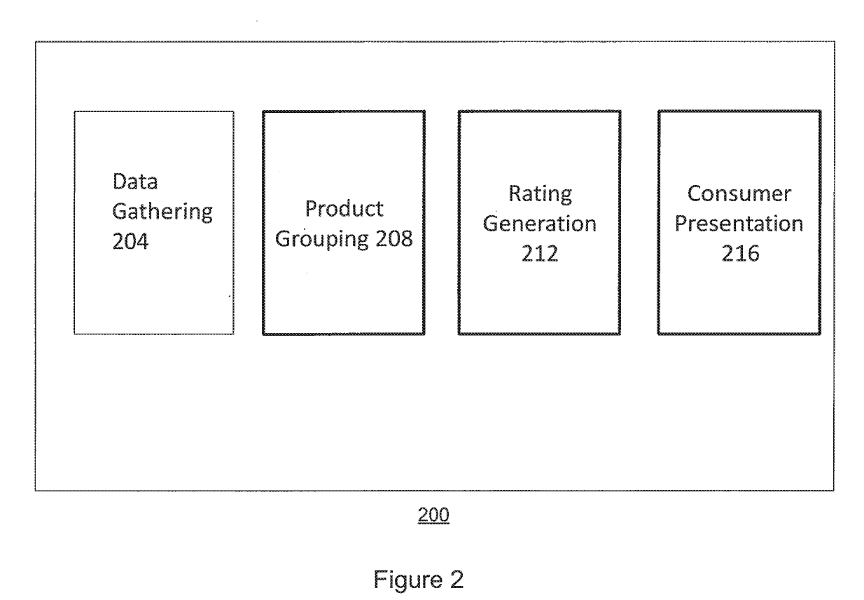

Referring to FIG. 2, which is a block diagram illustrating certain functional components or elements of an embodiment of the inventive Product Rating Aggregation and Prediction Service Platform 104 depicted in FIG. 1, an exemplary embodiment of the Product Rating Aggregation and Prediction Service Platform 200 will typically include the following functional elements, processes, or components (which in some embodiments may take the form of a properly programmed data processing element, which operates to execute a set of instructions, where the instructions are in the form of a set of computer software commands and may operate to access data):

1) Data gathering 204: an object of this component is to gather product data and review data about products from a variety of sources. The information gathered may then be used to generate product rankings/ratings;

2) Product grouping 208: an object of this component is to group variants of the same (or substantially equivalent for purposes of the processes of the invention) underlying “baseline” product together to ensure that the relevant reviews are associated with the variants of the product, and to ensure that the generated ratings/rankings are uniform with respect to variants of the product;

3) Rating generation 212: this component implements a primary algorithm for generating a rating from product data and reviews, and will be described in greater detail herein; and

4) Consumer Presentation 216: this element includes one or more data display aspects of the invention, including the display to a consumer of rating(s), and may include a display of reasons for the generation of a rating.

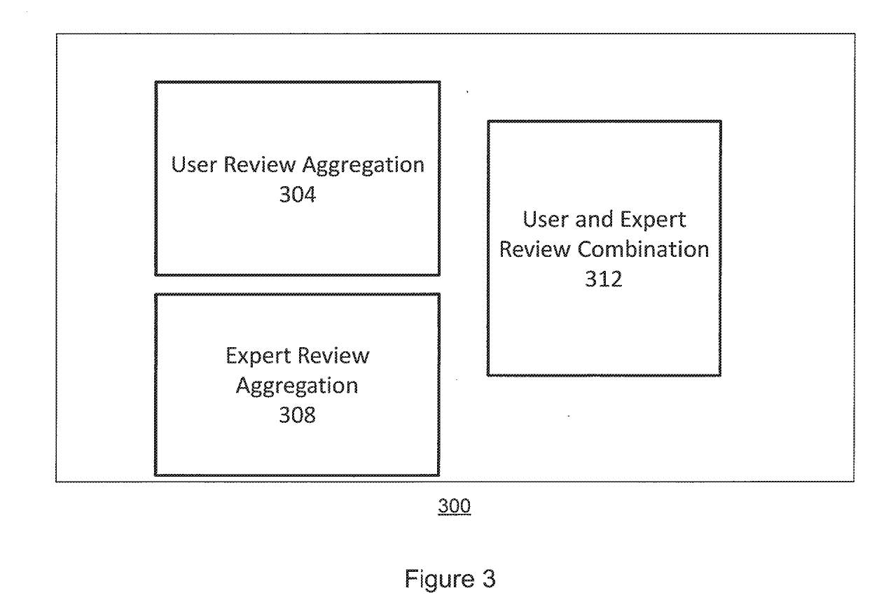

Referring to FIG. 3, which is a block diagram illustrating certain functional components or elements 300 of an embodiment of the inventive rating generation system that operates to aggregate expert and user review information (e.g., component 212 of FIG. 2), an exemplary embodiment will typically include the following functional elements, processes, methods, or components:

1. User review aggregation 304: this component or process operates to aggregate and normalize reviews obtained from multiple consumer sources in order to remove inherent biases in the data;

2. Expert review aggregation 308: this component or process operates aggregate and normalize reviews obtained from multiple expert sources in order to remove inherent biases in the data; and

3. User/Expert review combination 312: this component or process operates to generate a product rating based on the aggregated consumer/expert review content.

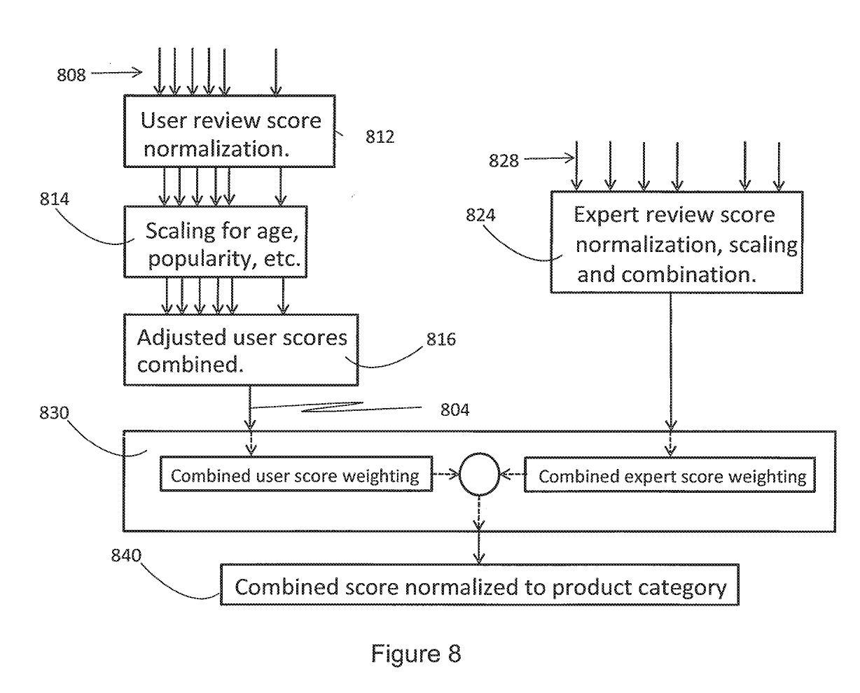

Note that FIG. 8 and the accompany description (including the description in the section entitled “Deriving Product Ratings from Combining Past User/Expert Reviews”) provide additional implementation details regarding an embodiment of the user/expert review information aggregation components.

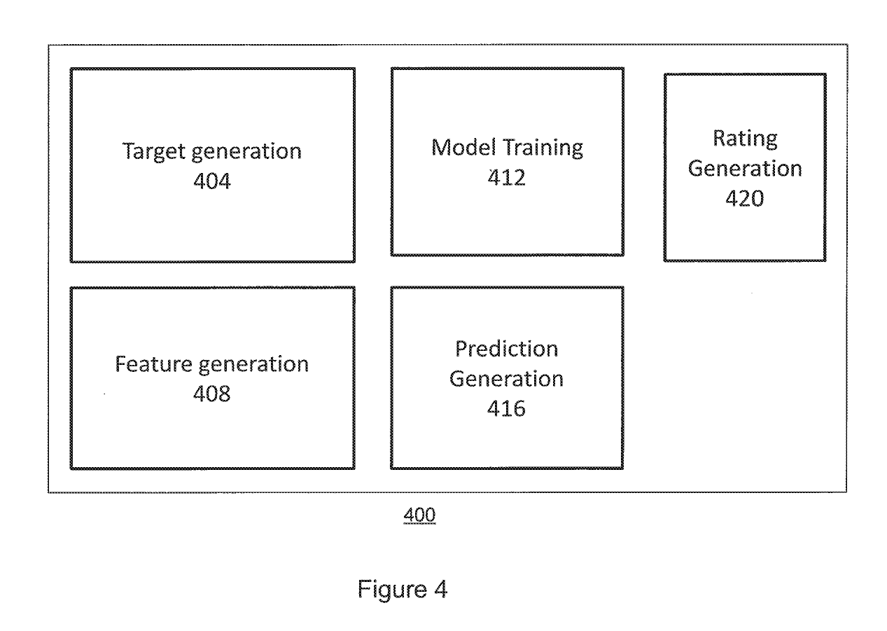

Referring to FIG. 4, which is a block diagram illustrating certain functional components or elements 400 of an embodiment of the inventive rating generation system for predicting aggregate review behavior based on future reviews and ratings (e.g., component 212 of FIG. 2), an exemplary embodiment will typically include the following functional elements, processes, methods, or components:

a. Target generation 404: this component is responsible for generating training labels for a machine learning system (or model) from a historical stream of product review data;

b. Predictive feature generation 408: this component is responsible for generating features from a historical stream of product review and product data that the machine learning system will then use to “predict” the desired target (as defined in 404);

c. Model training 412: this component is responsible for generating a candidate machine learning model based on the output of components 404 and 408;

d. Prediction generation 416: this component is responsible for applying the machine learning model generated by component 412 to present product data (e.g., features generated in 408 based on up-to-the-present product data and reviews), and

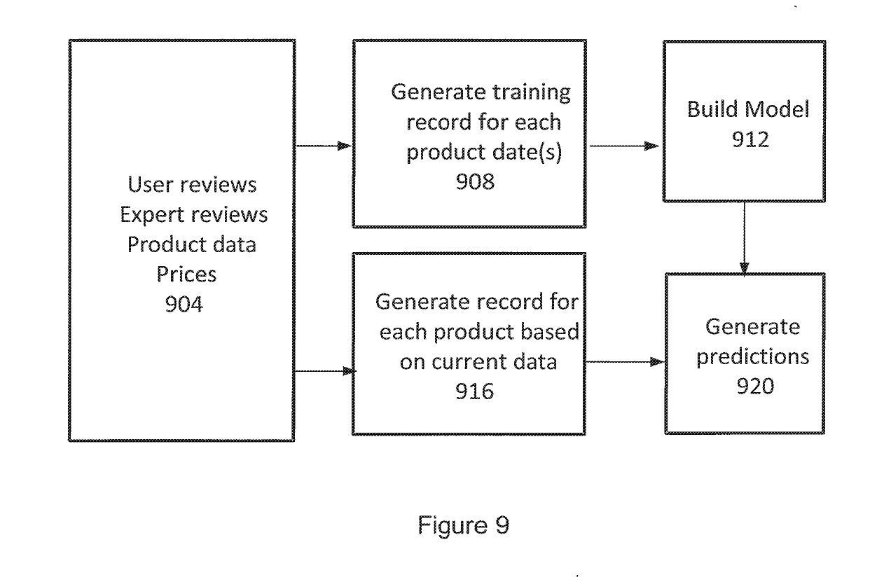

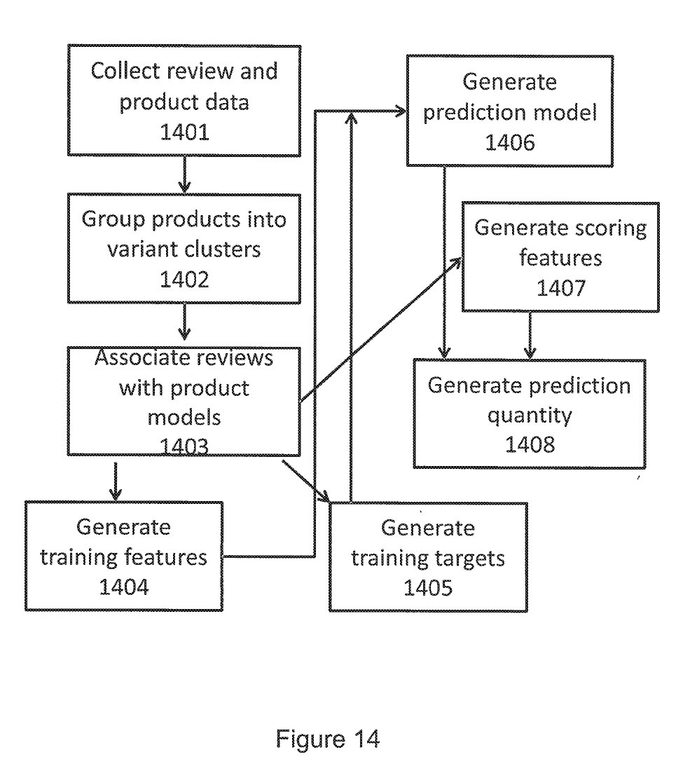

e. Rating generation (transformation of prediction into rating) 420: this component is responsible for translating the prediction generated by the machine learning model into a more easily understandable score, rating, ranking, etc. Note that FIG. 9 and the accompany description (including the description in the section entitled “Predicting Aggregates of Future Ratings”) provide additional details regarding training of models of the type that may be used as part of implementing an embodiment of the invention. A further workflow of a predictive system using a trained model to predict a future review-based quantity is described with reference to FIG. 14.

In accordance with at least one embodiment, target generation component (404) of FIG. 4 may comprise elements operable to perform the functions or processes of one or more of the components described with reference to FIG. 3 (e.g., user review aggregation 304) on a set of reviews and ratings across a given time period. In accordance with at least one embodiment, the user or expert review aggregation component(s) described with reference to FIG. 3 (or specific elements or information that is used during the review aggregation phase) may be implemented by use of predictive (aggregate) rating generation component(s) as described with reference to FIG. 4.

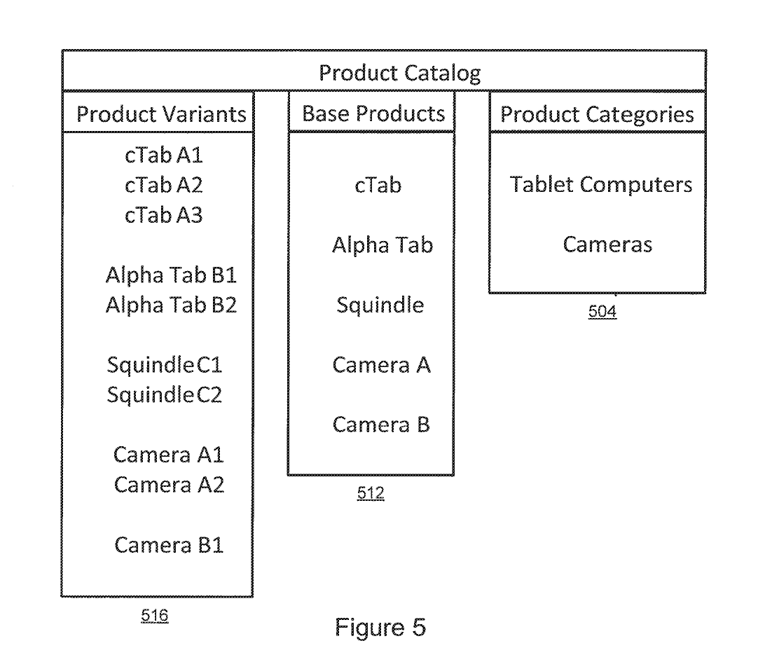

Referring to FIG. 5, which is a diagram illustrating a data model suitable for use in implementing an embodiment of the inventive product review aggregation service (and that may be used in implementing one or more of the data gathering 204 or product grouping 208 functions illustrated in FIG. 2). Categories 504 of products for review aggregation are defined, for example, tablet computers and digital cameras. In one embodiment, the various products in a given category 504 can be divided or separated into base products 512 and product variants 516 that are associated with particular base products. For example, a manufacturer may produce a particular type of tablet computer, the cTab, which is available in specific configurations, based on color selection, memory size, network connectivity, etc. Each specific cTab configuration (illustrated as cTab A1, cTab A2, and cTab A3) would be considered a product variant associated with the cTab base product. In one embodiment, these base products 512 are used to match reviews to products. Note that when a consumer writes a review on an online shopping website, the review tends to be associated with a specific variant of a base product, but the review (or at least certain aspects) may be applicable to some or all similar variants. For instance, one consumer may write a review associated with a black 16 GB model cTab and another consumer may write a review associated with a white 16 GB model cTab. While the reviews are for two different variants of a base product, some or all of the review content can be applied to the cTab base product.

Data Gathering and Matching System and Methods

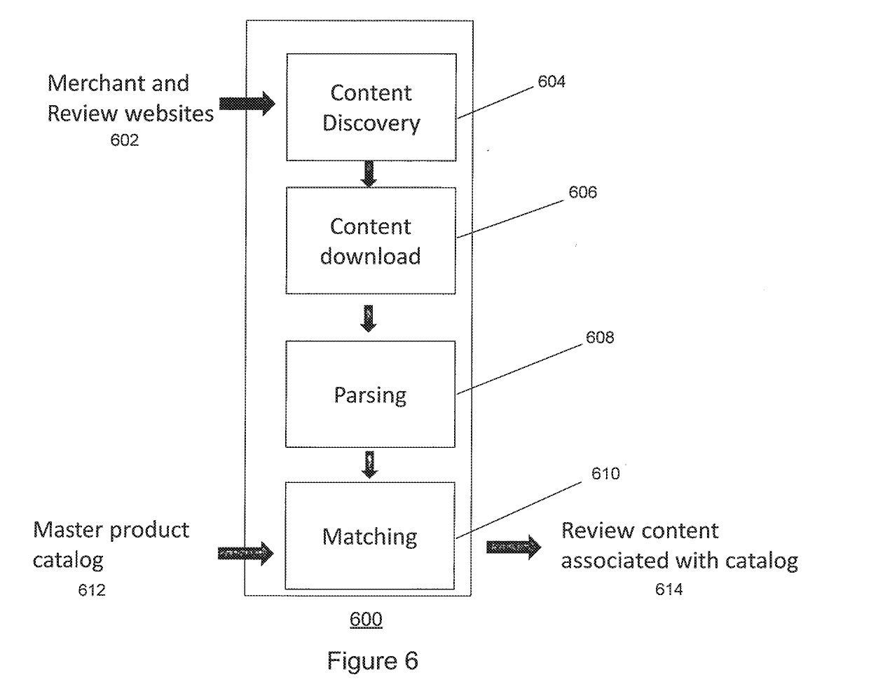

In at least one embodiment of the inventive system, apparatuses, and methods, consumer and expert reviews are collected via a combination of web page “scraping” and partner feed ingestion. FIG. 6 is a diagram illustrating a data collection process 600 suitable for use in implementing an embodiment of the inventive product review aggregation service. Note that some or all of the stages or steps illustrated in FIG. 6 may be implemented by a suitably programmed processor or processing element, such as a microprocessor programmed to execute a set of software instructions. As shown in the figure, in the data collection process different review sources 602 (e.g., merchant sites and/or expert review sources) are associated with a data collector that is configured to download and extract review/rating content specific to that source. The output of the source-specific data collection is review content that may be structured and include one or more of the following information or data types:

| Field | Description |
|---|---|
| Product Id | The identifier of the product the review relates to |
| Source Id | An identifier for the source where the review came from |
| Rating | The rating assigned to the product |
| Date | The date when the review/rating was generated |
| Additional | In general, the invention can extract other fields |
| Fields | such as pros/cons, summary, and review content |

In one embodiment of the invention, data collection from a specific source may comprise the following process stages or steps:

1. Content Discovery (604): a purpose of the content discovery stage is to determine content that pertains to product reviews and ratings. An output of this stage may be a set of URLs that represent web pages that contain review content;

2. Content Download (606): this stage involves downloading the content for the URLs “discovered” in stage 604;

3. Parsing (608): in this stage, specific information for reviews/ratings is extracted. This may include the review content itself, ratings, review date, and/or information that may aid in associating the review to a specific product; and

4. Matching (610): in this stage, parsed review content is matched against an authoritative set of products (for example a Master product catalog 612). An output may be a set of content obtained from reviews that has been associated with a product or service found in the catalog (614).

Note that these stages may be implemented in different ways for different sources of data. In particular, the discovery, parsing, and matching processes may be performed via different strategies, with the choice of a particular strategy depending upon the data source, data type, and data content.

In one embodiment, user reviews may be collected as part of a web page “crawling” process and may be used as part of collecting data about a merchant's catalog. Alternately, URLs for review pages for a merchant can be generated from known SKU's for that merchant, where such information may have been collected via an alternate means (e.g., affiliate feed ingestion). User reviews can be collected directly from the review URL pages. Expert reviews can be collected via an automatic scraping process for sites that have a large number of reviews. For smaller expert review sites, it may be more efficient to manually collect review URLs for scraping.

Content discovery (604) may include a process of finding the location of review/rating content on a merchant site. In one embodiment, content discovery may be done manually where a person examines the site in question and records URLs that correspond to review content to download later. This is suitable for sites which have a limited amount of content. In another embodiment, content discovery may be implemented by specifying a set of seed pages that a crawler can then follow links for, in order to generate potential review content pages. The crawler may start at the root pages and follow links to find pages that may be associated with review content and record them. Furthermore, pattern matching or machine learning may be used to determine which pages are likely to contain review content so as to filter out pages that are not necessary to download.

Parsing (608) is a process of extracting structured review/rating information from a downloaded review content web-page. Parsing may be implemented using any suitable method or process, such as by specifying patterns (e.g., regular expressions) that correspond to specific types of information and detecting occurrences of those patterns in the page URL or page content. A parser may also be generated via an automated information extraction system—such a system may rely on tagged data/information comprising review content from each source to be parsed, where portions of the review content are associated with specific fields to be extracted (e.g., review rating, review date, title). Such tagged data/information may be used as training data in an information extraction learning algorithm (e.g., conditional random fields) to condition an extractor for the desired information. Parsed information may include one or more of the rating, review date, review content, and meta-information that can be used to establish the product that a review is associated with. Additional description of suitable data extraction methods and processes may be found in U.S. patent application Ser. No. 13/863,558, entitled “System and Methods for Generating Controlled Risk Price Guarantees for Consumers”, filed Apr. 16, 2013, assigned to the assignee of the present application, and the entire contents of which is incorporated herein by reference for all purposes.

Matching (610) is a process of associating particular products or groups of products with the relevant review (and hence with the data/information extracted from the reviews). In one embodiment, matching may be performed in a manual fashion, where a person specifically enters an identifier for the product that the review is associated with. In one embodiment, this manual approach may be augmented with an intelligent tool that suggests likely products that a review may be associated with. The suggestions may be determined via multiple techniques such as search-based relevance formulas (e.g., Term Frequency-Inverse Document Frequency, TF-IDF) and matching of extracted features with known product features. A computation of association likelihood (and hence a measure of the accuracy of the matching process) may be generated via information retrieval methods that compute the similarity between review content text and product titles, or more sophisticated methods that look at structured attributes that can be extracted from product descriptions and review content.

In another embodiment, a master catalog of products may contain the SKU's that are associated with the product. In addition, SKU's may be extracted during the parsing phase as that process is applied to the review content, and an association can be made when the SKU associated with a review intersects with the SKU associated with a product in the master catalog. This is especially suitable for merchant sites, where the SKU is usually encoded in the product page URL using a fixed or discoverable format. Once the product review/rating data has been gathered and matched, it can be stored in a database, a set of flat files, a hard disk, flash memory, a “cloud” based data storage server, or other suitable form of data/information storage.

The specific data collection and processing strategy used may depend upon the volume of data, the type of data or content, the source of the data, etc. Below are some exemplary data collection and processing strategies that may be used. The relative desirability of each with regards to a specific situation may depend (at least to some extent) on the volume of data, the data source, or data type, among other attributes.

a. Content Discovery Function:
i. If the source has a relatively small (e.g., in the hundreds of pages) volume of content, one may manually collect URLs for content location; and
ii. For any suitable source, a process that uses an automated “crawl” and identification of content pages may be used. The crawl may be implemented on a computer or cluster of computers, and typically follows hyperlinks from a set of seed URLs to discover content pages.

b. Matching Content to Products Function:
i. If the source content has a link to a known merchant product page or is a merchant product page, it may be possible to analyze the link URL or link page to determine the SKU of a product. For example, in some cases the SKU can be obtained by parsing the link or page if the merchant has a known structure for generating URLs or content. The SKU can then be matched against an internal master catalog of SKUs to internal product identifiers. The master catalog SKU-to-product mapping can be generated by one of several suitable methods, such as finding merchant offers that share the same universal product code (e.g. UPC); and
ii. If the source content has no link to a merchant product page, then the matching can be generated via manual effort, automated matching algorithms, or a combination of the two (e.g., automated matching to generate candidate matches that are then verified manually).

Detecting Variants and Applications for Product Ratings

In accordance with one embodiment of the inventive system and methods, consumer and/or expert reviews may be matched to base products in a defined category. Each review may then be analyzed with respect to the associated base product and with respect to similar base products in the same category to determine an aggregate rating or score. Part of this process may include accounting for potential biases in the ratings/scores provided by the reviews, as well as how recently the reviews were written. Based on the product's aggregated rating score, a high-level recommendation about the product may then be provided, for example, “excellent,” “good,” “satisfactory,” or “not recommended.”

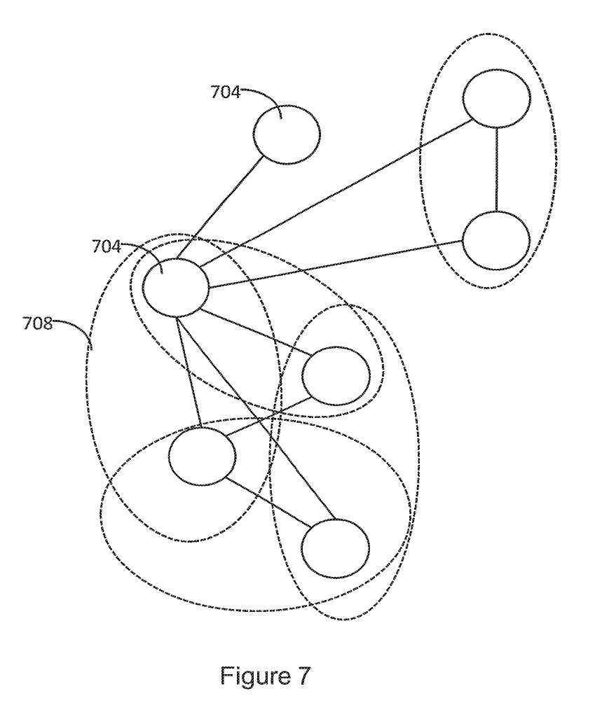

FIG. 7 is a diagram illustrating a product or service clustering technique that may be used to implement an embodiment of the invention. Referring to the figure, in accordance with at one exemplary embodiment of the product grouping step 208 (and/or as part of matching stage 610 of FIG. 6), products 704 in a particular category are gathered into clusters 708 of products, such that all products 704 in a cluster 708 share a certain characteristic. Specifically, all products in a cluster may be associated with a single base model or have a common set of features or specifications. A person having ordinary skill in the art will recognize that there are many potential ways to generate product clusters 708, including but not limited to having a human annotator create the clusters manually. An alternative approach is to generate clusters using a suitable heuristic, such as creating clusters from products with manufacturer part number (MPN) overlap, technical specification overlap, common feature overlap (e.g., a differentiating feature such as processor type, size of data storage, capacity, motor size, etc.). In addition, websites or other data sources may be crawled to discover relationships between one or more variants of a base product. As an example, some sites may provide links to other variants of a product on the product page. In accordance with one exemplary embodiment of the present method and system, the following methodology may be used:

(1) a subset of a category of products Y are grouped into all possible pairs (xᵢ, xⱼ) and it is manually determined whether or not a given product pair (xᵢ, xⱼ) should be in the same product cluster, the subset being much smaller than the total number of products;

(2) a set X of manually identified pairs (xᵢ, xⱼ) belonging to the same cluster and a set X′ of manually identified pairs (xᵢ, xⱼ) not belonging to the same cluster are used as respective positive and negative training examples to train a model to classify whether the remaining possible pairs (yᵢ, yⱼ,) of products in the product catalog are in the same cluster, resulting in a set Y of cluster pairs or, more specifically, a set of predictions about what products are in the same cluster as one another. By way of a non-limiting example, in order to cluster product pairs, such a model may utilize parameters such as technical specification overlap and information retrieval metrics, such as cosine similarity and term frequency-inverse document frequency (TF-IDF), between titles and MPN substrings; and

(3) agglomerative clustering using the set of predictions to cluster the pairs (yᵢ, yⱼ) in set Y into larger product clusters using the similarity metric found from applying the trained model—small clusters are combined based on the “distance” between the products in the clusters. The distance between two products yᵢ and yⱼ may be defined as the probability yᵢ and yⱼ are not in the same cluster and the distance between two clusters is the average distance between all possible pairs in the two clusters (or another suitable measure, such as distance between the centers of “mass” of the clusters). Two clusters may be combined as long as the average distance between the clusters is less than 0.5 (meaning the probability that they are the same cluster, and thus are the same base product, is greater than half).

In one embodiment, features that are used to predict the probability that two products belong to the same cluster may include one or more of:

1. Whether two products share the same MPN (manufacturer part number);

2. Similarity between prefixes of the MPNs for the corresponding products;

3. % or # of features that the two products share; and

4. Cosine similarity between product titles augmented by MPN and MPN prefixes.

In one embodiment, hard-coded constraints may be specified to ensure that certain products are not placed in the same cluster. For example, products with different brands, or televisions with different screen sizes may be forced to belong to different clusters (similarly, other product features that are expected to be used as differentiators by consumers can be used to enforce certain types of clustering or prevent certain types of clustering).

In one embodiment, a “random forest” technique may be used to train a classifier that estimates the probability that pairs of products belong to the same cluster. However, note that a classification algorithm that is able to produce a confidence or probability score can be used for the same purpose. Examples include certain support vector machines, neural networks, logistic regression methods, decision trees, and boosted classifier ensembles.

After the clustering process, the product clusters may be manually verified and split up (or merged) with other clusters as necessary. One or more of the steps of the described clustering methodology may be repeated until the set of products are suitably clustered. In an exemplary embodiment of the inventive system, this may be performed using a custom software dashboard that assists a user by displaying the “closest” possible cluster merges.

Referring to FIGS. 5 and 6, once the products in a given product catalog have been clustered into appropriate base products and associated product variants, it is desirable to calculate the product rating for each base product. The aggregate score is typically calculated at the granularity of the base product models, instead of at the level of individual product variants. This ensures that variants of the same base product are associated with the same rating score.

Deriving Product Ratings from Combining Past User/Expert Reviews

FIG. 8 is a flowchart or flow diagram illustrating an exemplary process for generating a base product's combined aggregate review score (CAR) from past user and/or expert reviews, and may be used to implement an embodiment of the invention.

As shown in the figure, one aspect of a base product's CAR is a combined user review score (S_{U,C}) 804. The raw user review scores (RS_{U}) 808 used to calculate the combined user review score S_{U,C} are drawn from various sources and typically will be normalized 812 by source and category. This is because it is common for different review sources to use different scoring scales (e.g., one source might largely score products between 40 and 70, while another may largely score products between 60 and 90). Similarly, categories may have different score ranges (e.g., digital cameras might range from 50 to 80, while televisions might range from 40 to 80). To normalize the scores, the mean user score M_{US} and standard deviation SD_{US} of user scores per source and category may be calculated. The normalized user score NS_{U} for each review RS_{U} may then be determined according to the equation:

$${NS}_{U} = \frac{{M}_{US} - {RS}_{U}}{{SD}_{US}}$$

Next, in one embodiment of the inventive system and methods, the combined user review score S_{U,C} based on a set of user reviews for the variant products associated with a given base product, would be calculated (as suggested by stage 816). Such a calculation may take several factors into consideration (as suggested by stage 814). For example, not all products have the same number of user reviews, so some uncertainty regarding the population distribution of reviews may be taken into account. Additionally, if there is a significant amount of uncertainty with regards to some aspect of (or data for) a product, then it may be desirable to penalize the product's score. In addition, more recent reviews are typically favored over older ones, as the older ones may be less relevant to product characteristics of current interest to consumers. For example, a product that was released in 2010 with a certain feature set may have gotten a relatively high score at the time because that feature set was “cutting edge” in 2010. However, two years later, the same product with the same feature set may be considered average when compared to the latest models. Because the model release cycle differs per product category, the threshold for determining whether a review is recent or outdated is preferably determined on a per category basis. For example, cameras, laptops, TVs, video games, and other categories which frequently have newer models released, may categorize reviews that are 6 months or younger as being recent, whereas for appliances, reviews that are 24 months or younger might be considered recent.

A number of dummy user reviews (D) may be added to the population of reviews associated with a product before computation of the user scores. This may serve several purposes: (1) it ensures a standard deviation >0, which prevents numerical instability; and (2) the combination of the dummy reviews and standard error formula serve to penalize products with fewer reviews, which is an indirect measure of the product's popularity. When this approach is combined with a time window, one of the implications is that the inventive system and methods act to penalize products that are nearing the end of their life cycle. Note that as products get older, and fewer people buy them, fewer people write reviews about them. Consequently, the smoothed standard error analysis described herein causes scores to decrease organically over time. The number of dummy reviews that is added may be specialized for different sub-populations of a product. For example, it may be desirable to use more dummy reviews in categories where people naturally tend to write more reviews, and fewer in those where review writing is relatively rare. More generally, this smoothing parameter may be derived from the expected number of reviews a new product of the sub-population should contain. Such a quantity may be derived or inferred from past data on the sub-population.

To determine the combined user review score S_{U,C} for each product p with N normalized review scores r₁ . . . rₙ, the adjusted normalized mean (ANM) and the adjusted normalized standard deviation (ANSD) may be calculated:

$$A N M = \frac{\sum {}_{1}^{n} r}{( D + N )}$$

$$A N S D = \sqrt{\frac{\sum {}_{1}^{n}{( r - A N M )}{}_{}^{2}}{( N + D )}}$$

A confidence interval may then be calculated and the lower bound (CI_{L}) used as a representative score for user reviews. This ensures that if two products have the same distribution, but one has four reviews and the other has two hundred reviews, then the product with two hundred reviews will have a higher lower bound on the confidence interval:

$${S}_{U , C} = {CI}_{L} = A N M - \frac{A N S D}{t * \sqrt{D + N}}$$

In one embodiment, it is desirable to remove potential biases that may skew the number of people that review a product. This is important because the volume of reviews may have a large impact on the final aggregate score. One bias that may exist in some categories is that more expensive products usually have fewer reviews, because fewer people tend to buy them. In accordance with one embodiment, review price biases can be mitigated by weighting reviews based on the price of the product. In practice, the inventors have recognized that the number of reviews a product receives roughly follows a power law distribution of the price of the product. Thus, for a product with price P, the model can adjust the weight of its reviews according to a power-law distribution for the category. In one embodiment, the parameters for the power-law distribution can be estimated based on existing review and price data as follows:

1. find the price and number of reviews for all products within a category;

2. eliminate outliers that are likely to be bad data (e.g., the cheapest 1% and most expensive 1% of products);

3. divide the prices into different buckets, to group similarly priced products together (products people would likely have considered close enough price-wise to allow for quality factors to determine their choice);

4. find the product with the highest number of reviews in each bucket, and record the data point (price, # of reviews) for that product; and

5. fit a power law distribution to those points to get a function estimating the expected best case of number of reviews at a particular price point−numReviews(P)=Ae^{b*P} for parameters A and b, and product price P. This curve or function fitting may be done using numerical methods or heuristics (e.g., fitting a line in log-log space). Additionally, it may be necessary to bound parameters A and b to reasonable values.

In one embodiment, each review may be re-weighted via the following formula:

w(P)=numReviews(P)/numReviews(P₀),

where P₀ is the price of a standard product (the price where w(P)=1). In practice, setting P₀ to the 20^{th} percentile price for a category seems to work well. The user review aggregate formulas described previously can be altered to reflect the reweighted reviews as follows

$$A N M = \frac{\sum {}_{1}^{n} w ( P ) r}{( D + w ( P ) )}$$

$$A N S D = \sqrt{\frac{\sum {}_{1}^{n}{( w ( P ) r - A N M )}{}_{}^{2}}{( D + w ( P ) )}}$$

$${S}_{U , C} = {CI}_{L} = A N M - \frac{A N S D}{t * \sqrt{D + w ( P )}}$$

Another factor (or potential bias) which may be modeled is the latency between when customers buy a product and when they typically write a review for that product. This latency impacts the accuracy of an estimate of product popularity that may be inferred from the volume of user reviews, and indirectly may decrease the ability of the confidence interval target function described herein to generate an acceptable product quality ranking. One way to mitigate this impact is to incorporate a heuristic decay factor that is applied to the number of reviews at any point in time, and which is dependent on product age. Another way to mitigate the impact of this factor would be to decrease the count of reviews based on the distribution of the latency between product purchase and the writing of the review.

Alternatively, the number of purchases of a product based on the number of reviews may be estimated by modeling the stream of written reviews using a dynamic Bayesian network (for example, a Kalman Filter or switching Kalman Filter) that models the joint distribution of written reviews over time and accounts for estimated variables such as the number of purchases, where the observable variable represents the number of reviews written in a time period and the hidden variable(s) represent the number of people that purchase the product during the same time period and the number of people who have yet to write a review. The parameters of this Bayesian network (e.g., the probability of a purchasing consumer writing a review, the change in the rate of purchases over time) can be trained via an expectation-maximization algorithm over a dataset that comprises review count sequences for different products. At prediction time, one can substitute the inferred number of purchases for the number of reviews over a given time period in the preceding formulas.

In accordance with one embodiment of the inventive system and methods, it is desirable to calculate (as suggested by stage 824) a combined expert review score S_{E,C} for a given base product using (n) expert reviews (as suggested by stage 828). Similarly to the method for calculating the combined user review score S_{U,C} described herein, the expert review scores may be normalized to account for uncertainty. Products that have several sources for expert reviews may be rewarded, with the relatively large number of sources being used as a proxy to indicate that the base product is popular. However, in doing so the release date of the product should be considered, as newer products will most likely have fewer reviews and it would be counter-productive to penalize new products in that manner. To determine the combined expert review score, for each product p with normalized review scores (e₁ . . . eₙ), one can calculate the adjusted normalized mean:

$${S}_{E , C} = \frac{\sum {}_{1}^{n} e}{n + ln ( RD )}$$

Where RD equals the number of days since the release of the product (and may be set to 365 by default if a release date is unknown).

In accordance with one embodiment of the inventive system and methods, the combined user review score and the combined expert review score may be further combined (as suggested by stage 830) into a single, weighted, raw aggregate review score (RARS) for a base product:

RARS=Expert Review Score Weight*S_{E,C}+User Review Score Weight*S_{U,C}.

Depending on the base product category, either the combined expert score or combined user score may be weighted more heavily. Restrictions may also be imposed on a per category basis. For example, for the digital camera category it may be desirable to include a base product's calculated combined expert score S_{E,C} only if the number of expert reviews (n) is five or greater. Otherwise, the base product's RARS will be based only on the calculated combined user score S_{U,C}.

In accordance with one embodiment of the inventive system and methods, it may be desirable to use the raw aggregate review score for each base product to determine a mean raw aggregate review score (MRC) and a standard deviation of all raw aggregate review scores (SRC) across a given product family, and thereby determine a normalized aggregate review score (NS) (as suggested by stage 840) with respect to other base products in the same product category:

$$N S = \frac{RARS - M R C}{S R C}$$

Based on consumer expectations, it may be desirable for the final combined aggregate review (CAR) scores to be between 0 and 100. To accomplish this, one can put the normalized aggregate review scores NS through a sigmoid function to calculate the final scores:

$$C A R = 100 * \frac{1}{1 + {e}^{- NS}}$$

Note that using the sigmoid function helps distribute the scores around the mean into a diverse set. The sigmoid function is “tuned” so that an average product in any category will have the same score, and the score spread is roughly similar across all categories.

As an alternative, instead of using a sigmoid function, the scores can be distributed using a fixed curve where the number of products that are scored in each interval are constrained by a constant number or by a percentage of the number of products in the category. As an example, a constraint such as MIN (10, 5% of product population) may be required to score above 90. The final scores may then be adjusted to satisfy the constraint.

Note that merchant product availability and expert review coverage for specific products may not be consistent. Expert sources typically have a limited amount of time and so cannot review the entire landscape of products. Certain manufacturers may have exclusive deals with certain merchants, which impacts inventory at stores. These factors can affect the set of expert and user reviews available for a product and therefore may adversely impact the effectiveness of product ratings.

Using Predicted Future Ratings to Evaluate Product Rankings

The quality or reliability of a product rating process such as those described herein may be difficult to assess. Existing methods of assessing the quality or reliability of a product rating process may be slow to perform (taking hours, days, or even weeks) and may be difficult to generate with good coverage or in an unbiased fashion. As mentioned, these methods include manual examination by human evaluators of the generated product ratings and/or A/B tests of candidate product rating systems on a website.

However, as recognized by the inventors, the techniques and methods described herein may be used to evaluate the accuracy and reliability of a product rating or ranking process. As an example, the inventive techniques and methods may be used to create a system and process for automatically evaluating the quality of product rankings or ratings methods based on how well the generated ratings/rankings measure future popularity of a product and user satisfaction with that product. Qualitatively, this makes sense as a measure of a product rating system—the products that people will buy and rate highly in the future are the ones that should be ranked/rated highly at present by a rating system.

In one embodiment, the inventive system for evaluating product rating methods is able to measure the ability of a candidate rating algorithm or method to “predict” future product ratings by simulating the performance of the algorithm on product ratings/reviews (and in some cases other data) that are time-stamped. In such a simulation, certain information about a product is associated with a point in time when the information became relevant for that product. As an example, in the case of reviews this can be the date the review was created or published. For product purchase volume data, this date could be the dates of product purchases. For product prices, this can be the date associated with each product price (such as when that price for the product was offered to the public). For reference product data (e.g., model series, brand, certain technical specs, etc.), it is assumed that such data is known from when the product was first available to the public.

In one embodiment, a system for evaluating product rating methods has three inputs: (1) An “ideal” target function that is computed over known information; (2) A candidate rating system or method for which the “quality” is to be determined; and (3) time-stamped product review/data, as described herein. Using these inputs, evaluation of a rating method's quality may include the following steps:

1. The candidate rating system or method is applied to product data at different points in time to generate product ratings that would have been created, given the information known at those points in time. In addition to the generated candidate rating, a ranking that is applicable to these specific points in time can be determined from the rating. Here a ranking is an ordering of products from best-to-worst with respect to some metric. A reason to differentiate between rankings and ratings is that, dependent on whether one is evaluating a predicted ranking or a predicted rating, the metrics used to measure the error or accuracy may be different. The choice as to whether to focus on making an accurate ranking prediction or a rating prediction may ultimately depend on product considerations (i.e., how the prediction is used with respect to a product). For example, if one cares about showing the top 10 recommended products in different verticals, then evaluating the error of the predicted rank may make more sense;

2. The “ideal” target function rating for each product at the same point(s) in time is generated based on known information about the product. An ideal ranking may be generated for each product at each point in time based on the ideal rating. The result of these processes is that for each product and point-in-time, the following information is available:

| Product | Timestamp | Candidate Rating | Candidate Ranking | Ideal Rating | Ideal Ranking |
|---|---|---|---|---|---|
| Product ID | Test Point | Rating | Product Rank | Rating | Ranking |
| | in Time | Generated by | Induced by | Generated by | Induced by |
| | | Candidate System | Candidate Rating | “Ideal” target | Ideal Ratings |
| | | | | Formula | |

As an example, the current version of a laptop computer may have a separate evaluation record for every week that it has been available, with each week having an ideal rating/ranking based on the reviews that occurred in the next few months after that week. This data allows an evaluation of the quality of the candidate ranking/rating system based on its performance for the laptop throughout the product's lifetime; and

3. Given both an ideal rating/ranking and candidate rating/ranking for a product or products at multiple points in time, the quality of the candidate method can be assessed using one or more different metrics. Examples include, but are not limited to the average squared error between the candidate and target rating, the size of the intersection between the top ranked products generated via the candidate and target rankings, or the normalized distributed cumulative gain (NDCG) of the candidate ranking with respect to the ideal ranking. A person or automated process can evaluate multiple candidate ranking systems/methods against these metrics and select the “best” performing one. Note that because the quality of product rating methods can be measured at different points in time, automated metrics generated by this approach can cover more potential scenarios than existing solutions.

An issue that may benefit from additional description is that of specifying the “ideal” target function. This function/formula may be generated and then preferably evaluated either manually or via an A/B test. Note that even though the approach described may include a manual aspect, the solution described herein still streamlines the process for experimentation and evaluation of different rating systems or methods. If used, a manual process for generating and/or evaluating the ideal target function/formula typically need only occur once (as afterwards, the system can proceed without further manual evaluation). In contrast, when using existing processes for evaluating the quality of a product rating system, each potential change to a rating formula needs to go through a manual evaluation or A/B testing process. In addition, using the inventive approach the ideal target function can be evaluated over multiple points in time. Therefore, the range of possible scenarios covered during target function evaluation is expected to be greater than that of the conventional processes used to evaluate rating/ranking systems.

As an example embodiment of the approach described herein, the ideal target function may be the RARS formula described previously, where the user reviews used to generate the RARS are those that are authored in the (N) months after the timestamp for the candidate evaluation record. The inventive system and methods can be used to tune parameter(s) of the RARS formula for generating the candidate rating/ranking, such as the time period considered when calculating the RARS, etc. Other candidate target functions can include quantities such as the volume of reviews, average smoothed user review rating, or another quantity or formula that can be aggregated from product review data and/or product information.

Predicting Aggregates of Future Ratings

Instead of generating product ratings directly from a fixed formula for aggregating past user and/or expert reviews, the inventors recognized that machine learning techniques can be applied to historical product ratings data to create a model for predicting an aggregate quantity of future product ratings and reviews. The “prediction” can be transformed into a product rating, or be used as a component of a formula for product ratings (e.g., as a replacement for S_{U,C} in the aggregate rating system described previously).

The previous discussion described how “ideal” target ratings generated for a product at different points in time can be compared to ratings generated by a candidate method/algorithm using a metric that is the same or similar to the type of metric that a machine learning algorithm uses to optimize solution parameters from training data. In this section are described embodiments of the invention that permit application of machine learning methods to time-stamped product data in order to optimize the generation of product ratings in view of a desired optimization criteria. One benefit of this approach is that it relieves a person from having to manually try to tune the many possible combinations of product data that are possible in order to produce a high-quality ranking/rating formula.

A machine learning system for predicting future review aggregates operates in a way that is similar to the candidate ranking/rating method evaluation described previously. In one embodiment, the system takes as inputs: (1) An “ideal” target function with the description and restrictions described previously; and (2) time-stamped product review data (or other relevant data) as described previously.

FIG. 9 is a flow chart or flow diagram illustrating an example process for generating predictions of future product ratings that may be implemented in an embodiment of the invention. As shown in the figure, historical product ratings and other product data (stage 904) may be used to generate training data (stage 908) that can be used to generate models (stage 912). To generate current predictions for a product catalog, the system first generates predictive features for each product based on information known about the product currently (stage 916), and then applies the model learned in stage 912 to create the “prediction” (stage 920). Review data for a product may be collected along with rating, content, and the date the review was posted. To generate data for training models, a training example for each product at different points in time may be used. The features that the model uses are aggregated from reviews and ratings that have occurred in the past with respect to the time-stamp of the observation. The target used as a training signal for each example is based on reviews and ratings that occur in the future with respect to the time-stamp of the observation. In accordance with at least one embodiment of the invention, the training data is sent to a gradient boosted regression tree(s) to generate a model 912 that predicts the target quantity and that is trained to optimize the least squared error.

The function used to generate target labels for the machine learning problem can be based on a formula that takes into consideration future reviews and ratings with respect to the point in time that corresponds to the example. Suitable functions include the ANAM or S_{U,C} functions described previously (and as computed from user reviews in the next few months after the observation date). In general, the target may be a statistical quantity aggregated from the population of future and/or past reviews for the product (such as count, average value, standard deviation, median, etc.), or a function that is based on such a statistical quantity (such as a ranking that is derived from the statistical quantity).

A variety of available data can be used as a predictive feature in the prediction model, including but not limited to:

1. Review scores from known expert review sites (the score from a single site can form a single feature in the prediction problem);

2. Aggregates generated from user and expert reviews;

3. Aggregates generated from historical time series data of user and expert reviews (e.g., are reviews trending downward, is the number of submitted reviews declining?);

4. Product features such as brand, age, or technical specifications;

5. Information about the merchants carrying the product. For example, if a product is only available from relatively small sellers, one may infer the product is near the end or past the end of its lifecycle;

6. Historical and current product pricing;

7. News and rumors related to the product or upcoming products (e.g., from social media, product or manufacturer “fan” sites, etc.);

8. Measures of product popularity, such as the sales rank of the product;

9. Extracted sentiments for the product based on reviews; and

10. Features derived from aggregating any of the information listed above from related products, where the relationship may be of different levels of granularity (e.g., same brand, same model series, same category, similar features, similar price points, etc.).

Note that an advantage of the inventive predictive framework is that many machine learning algorithms are capable of handling missing data via imputation, or explicitly within the algorithm itself (e.g., decision tree ensembles). This permits predictions to be made even when some features (such as expert reviews) are not present or are not present in sufficient numbers to provide statistically valid results according to conventional approaches.

Features derived from the information described above can be used to predict different quantities related to sales or reviews of products in the future. Below is a list of example quantities that may be “predicted” by using one or more of the elements, components, methods, functions, operations, or processes described herein:

1. Aggregate quantities based on reviews in the future (e.g., number of reviews, average rating, standard deviation, number of reviews at each rating level);

2. One or more of the quantities described herein, such as Sac. CAR, etc.;

3. A score or rating that a particular expert review source (that has not yet reviewed a product) would be expected to assign to that product;

4. Future merchant sales rank or sales volume; and

5. A product rank derived from one or more of the quantities mentioned above (e.g., rank of a product based on future values of S_{U,C}).

Given a set of predictive features and a desired target function, one embodiment of the inventive system operates to generate a dataset, where a dataset comprises one record for a product at a specific point in time. For that record, the predictive features are generated from data that is known up to that point in time (which can be determined in the case of reviews/ratings if the time-stamp associated with a review is stored along with the review content data). The target value may be generated based on known information about a product. For example, in one embodiment, the target value is generated based on user reviews that occur in the next six months after the time-stamp of the record. The data for computing the features and target function may be stored using any suitable technology or methods, including hard drive, cloud storage accessed via a network, thumb drive, tape drive, or other physical media. The features and the target for a record may be computed using a variety of computing technologies, including but not limited to databases or database queries comprising SQL or database stored procedures, NOSQL technologies such as document databases (e.g., MongoDB), map-reduce based systems such as Hadoop (or systems that are built upon Hadoop, such as hive or pig), or computer programs written in any computer understandable language ranging from binary to assembly language to higher level languages, such as C, C++, Java, Perl, python, or scala.

Predictions of a product rating may be obtained using a regression algorithm, in which case the goal is to predict the aggregate value generated by the analysis system based on future reviews. Such an approach can be implemented via any suitable model or methodology, including but not limited to decision trees, support vector machines, neural networks, Gaussian processes, non-parametric models (e.g., nearest neighbors or Parzen's windows), generalized linear models, or ensembles of one or more of the models mentioned. Such algorithms or models can be trained using a variety of approaches, including gradient descent, gradient boosted trees, random forests, support vector regression, or other suitable method. The algorithm(s) used may be configured to optimize for different loss functions. Typically, these types of algorithms are optimized for squared loss (i.e., least squares), but some can be configured to optimize for LI loss, Huber loss, or another suitable optimization method.

As an alternative, instead of generating a prediction of the overall aggregate rating for a product, the inventive techniques and methods may be used to determine a rank from the target rating, and use that to predict the future rank of a product. In this example, various learning algorithms may be used that are specialized for ranking, such as support vector machines, neural networks, or decision tree ensembles that are optimized for ranking metrics. Examples of such algorithms include, but are not limited to lambdarank, lambdamart, and NDCGBoost.

As another alternative, instead of predicting the overall future aggregate rating, the inventive techniques and methods may be used to predict the probability that a future customer will have an overall positive opinion (as opposed to a negative opinion) regarding the product. This task can be performed by posing the problem as a classification problem, and using a classification algorithm to train a machined learning model. Decision trees, decision tree ensembles, Bayesian networks, support vector machines, generalized linear models, and neural networks are examples of techniques that may be applied for classification (with the appropriate optimization criteria). Examples of specific classification algorithms that may be applied include support vector classifiers, logistic regression, gradient boosted trees trained to optimize log loss, and naïve Bayes.

In order to apply these techniques, a predictive rating problem may be posed as a classification problem. This may be accomplished by changing the target rating into a “Positive” or a “Negative” target. This can be done by randomly assigning the label with a probability in proportion to a monotonic transformation of the future aggregate quantity, as scaled to between zero and one. As an example, the sigmoid transformation from NS to CARS described previously may be suitable for this purpose. Another option is to create both a “Positive” and a “Negative” labeled example for each record, but associate a different weight with each example in proportion to the future aggregate target (as scaled between zero and one).

In accordance with one embodiment of the invention, brand-level aggregate features may be generated and incorporated into the training process via a stacking approach. In stacking, base features are computed for the purpose of training models via cross validation (e.g., divide the dataset into N components and compute the values for the Nth component based on the other N-1 components). The cross-validated features are then used during the model training process. During the prediction phase, base features are created over the entire dataset population.

In addition to generating a prediction based on the target, an uncertainty parameter can also be determined, where this parameter is indicative of the expected accuracy of the prediction. The uncertainty parameter can be useful in evaluating how to interpret a product rating/ranking that arises from using the inventive system and methods. For example, if a product is newer and the uncertainty in the prediction is relatively high, then it may be best to provide a range instead of a single value for the product (with a corresponding message that “the product is too new for a more precise ranking”). One way to generate an uncertainty parameter is to explicitly predict an upper and lower bound on the prediction target via quantile estimation, such as a model that predicts the 10% and 90% quantiles. The gap between these predictions is directly related to the confidence that the prediction is correct. Quantile estimation may be performed via gradient boosted regression trees that are tuned to the appropriate error function. Other regression algorithms, such as linear regression, can be modified to estimate quantiles.

The description of the invention has discussed application of the inventive techniques to several “prediction” problems, including (1) regression, (2) using machine learning to rank, and (3) quantile estimation. Each of these problems or tasks introduces implementation options in terms of the learning algorithm(s) that may be applicable to the problem. In addition, different learning algorithms may be configured in different ways (such as with regards to decision tree depth). Further, the set of features that the learning algorithm uses may also have an impact on how well the overall system performs. Consequently, the process of choosing the learning algorithm to be applied can have a significant impact on the final system performance. As a result, it is important to consider whether general guidelines and processes exist that may be used to guide a decision with regards to which algorithm(s) are more likely to perform well for a specific application.

As recognized by the inventors, an “experimentation” or evaluation process may be created that permits investigators to examine the behavior of various regression algorithms, features, and/or target functions. Typically, such a process comprises dividing the data that the model uses into two portions, (1) a training set, and (2) an evaluation set. A candidate learning algorithm or method with a particular feature set can then be tuned on the training set via cross-validation to find one or more optimal algorithm parameterizations (or one can use a parameterization of the algorithm that has worked well in the past for the same or a similar situation). To test whether one algorithm or feature set provides improved performance relative to another, a model can be trained on the training data set and then have its performance evaluated using the evaluation data set. The metric chosen for evaluation may depend on the specific objective to be optimized. For example, one may optimize for least squared error for regression problems, or for NDCG for ranking problems. Using this type of process, one can iterate on different candidate features and different options for learning algorithms to determine a solution that is expected to perform well in the future.

In one embodiment, the inventive system and methods described herein can be used to enable website features or provide a service that returns a product rating prediction for a requested product. Deployment of such a system may include two basic processes, with the first being a training process which is used to generate trained models for making predictions, and which may be implemented in software, hardware, or using a combination of software and hardware. Either or both the creation of a dataset that can be used by a machine learning algorithm to train a model, and the algorithm for creating a model from the dataset may be implemented in this manner. The model may be stored in a physical media, or loaded directly into a service or software system for performing predictions.

The second process is a scoring process which is responsible for generating predictions for products. In general, a suitable scoring process should be capable of: (1) generating a record for each product that includes the predictive features that are used in the training process; and (2) apply the model generated during the training process to generate a prediction for the product. Unlike as in the training process, the prediction process may generate only a single value per product, based on known information about the product.

The scoring/prediction process may be implemented as a batch process that uses either software, hardware, or a combination of software and hardware. The output is typically a data set containing one record per product (which includes the prediction features constructed over information known about a product to date). The trained model may then be applied to this scoring data set to generate a prediction for each product. The product and its prediction may be stored in a database, file system, remote web service or cloud-based data storage element for retrieval, or loaded into the memory of a service that returns the associated prediction when queried with a product description or identifier. Alternately, the service responsible for generating the product rating may construct a scoring record when queried about a product, where such a record may include the prediction features constructed from known information about the product, and then apply the trained model to the product data. In this case, the prediction is performed on-demand rather than having predictions for a larger number of products generated and stored for later access. Note that a generated prediction can be translated into a product rating via a monotonic transform, similar to how the RARS may be translated into the CAR.

Predictive Sentiment Analysis

Typically, product review scores attempt to distill information about a product into a single number or value. While this is desirable for ease of use and high-level comparisons, it may not effectively capture the different tradeoffs that are relevant to different products, especially when two products receive a very similar score. For example, two laptops may both be highly rated (in terms of score), but targeted at different use cases that would make one preferable for a particular user (e.g., one may be a heavy, less portable, but high performance computer, whereas the other may be a lightweight, extremely portable, but lower performing computer). Although both may be excellent devices, using a single score to rate them does not capture these tradeoffs, or show how well they match different use cases. As recognized by the inventors, the techniques described herein with regards to creating product ratings based on predicting future aggregate review information may also be used to generate predictions regarding how future customers may view specific aspects of a product.

Since a single score does not provide insight into the aspects of a product that may be of interest to different consumers, some product reviewers may choose to present their evaluation of a product as a set of separate reviews focused on specific features or functions. This may be explicit (e.g., giving specific ratings for performance, portability, etc.) or implicit and described in the text of the review (e.g., “this laptop is very fast”, “this laptop is easy to carry”, etc.). Implicit “ratings” may be identified in a variety of ways, including using keywords, using learned attributes and values, or by using more advanced parsing and textual analysis techniques. Additionally, for such implicit dimensions, a properly constructed system can estimate a user rating based on heuristics, or more generally by training a machine learning classifier to estimate how positive or negative a user views a product with respect to the dimension in question (i.e., the user's positive/negative sentiment about the dimension).

Although methods for providing a more detailed breakdown of a rating or score along some of the possible alternate dimensions are known, they typically have two important limitations. First, such ratings are generated at a specific point in time, and so are based on the other products available at that time and the expectations attributed to products at that time. As such, the dimensional or sentiment type evaluations become less relevant as a product becomes older, and new products and technologies enter the market, etc. For example, a ten year old camera may have had relatively “excellent” image quality when it was first released, but as compared to more recent cameras it probably does not fare as well.

To address this limitation, an embodiment of the inventive system and methods may be used to generate a prediction of how a reviewer would rate a product at present based on a review created at some point in the past. Such a system may employ simple heuristics, such as lowering the ratings based on the review's age or the product's age, the specs of the product relative to other products on the market, and/or may be trained using machine learning techniques. These predictions can allow a system to make better recommendations, and automatically keep them fresher and more relevant, providing cost savings and helping consumers to make more informed decisions that take into account updates in technology, performance, and expectations that have occurred since a review was originally created.

Second, products are typically compared using either raw specifications (e.g., CPU clock speed) or user ratings (e.g., an implicit or explicit rating, as described above). However, using either one of these data sources alone may not be sufficient. In the first case, a technical specification may be misleading, since two products may have similar values but perform differently in practice (e.g., two cameras may have the same resolution, but due to different technologies/implementations one may produce more accurate, crisper, or better looking images). On the other hand, using ratings alone as a data source is similarly not sufficient. In addition to “noise” in the data, ratings often reflect the implicit expectations of the reviewer and can be difficult to compare across multiple products. For example, a reviewer may rate a cellphone camera as having excellent image quality and a midrange SLR camera as having average image quality, but most likely the images captured by the SLR camera are much better than those captured by the cellphone camera. Thus, ratings may be more dependent on a reviewer's expectations than on the absolute performance of a product.

To address these issues, in one embodiment of the inventive system and methods a hybrid approach that combines technical specifications and reviewer ratings along a relevant dimension may be used. A hybrid approach may rely on simple comparisons (e.g., using the raw specifications on resolution and sensor size to determine that the SLR camera will have better image quality than the camera phone in the example above, but break “ties” between two SLR cameras with similar specs by using the reviewer ratings regarding image quality). Or, a hybrid approach may use a heuristically defined function that produces a comparison (e.g., weighted voting across multiple independent specifications and extracted sentiments) or is trained using machine learning methods.

Additionally, ratings and product comparisons may be defined relative to other products that are available (e.g., at a given price point or within a category). This will permit a system to automatically adjust ratings to let consumers know how they can expect a product to perform relative to some or all of the available options (rather than just in comparison to the options available at the time of a review or those selected by a reviewer). This relative comparison information may be used as an additional “signal” in the machine learning techniques described herein, and/or may be presented directly to a consumer to help them make a more informed decision. For example, a consumer may learn that a camera has a 24 megapixel resolution, but may not know if that is a lot compared to other options. So for example, by telling them that it is higher than 95% of currently available cameras, they can make a more informed purchasing decision.

Note that the inventive system and methods are not limited to being used to combine such information for a single product. Instead, the relevant information may be aggregated along other dimensions of the same product, or across multiple products. For example, the reliability of a given product may be estimated by looking at reviews for comments about the product breaking, failing, wearing out, needing repair, etc. This can be useful information in itself, but the information may also be aggregated across all products released by a particular manufacturer. This can be helpful to users when considering a purchase of a newly released product from the same manufacturer that may not have many reviews (e.g., if the manufacturer's products have been relatively less reliable in the past, then a consumer may want to be wary of the new product). The same type of data combining may be useful in trying to detect or anticipate changes in consumer or reviewer expectations. For example, a company may be sacrificing quality to save money, new features in higher-end laptops can often be introduced into midrange ones in the near future, etc. Additionally, these higher level aggregations may be useful in predicting updated ratings, as described previously.

As noted, it can be useful to predict what a reviewer's ratings of a product would be at present, as opposed to when a review was written, taking into account changes in expectations and other products released since the time of the review. Such predictions are valuable since they will enable consumers to make more informed purchasing decisions by having information they can use to make more reliable comparisons of products that are available at the time they are considering a purchase.

Similarly, the inventive system and methods may be used to “predict” how ratings written today will change in the future. One benefit of this type of prediction is that it may be used to reduce or eliminate “buyer's remorse”. For example, if a consumer knows that it is likely that a product they are considering buying at present will have a certain level of product quality rating/review two months in the future, then he or she will be better equipped to make a purchasing decision that they will be happy both at present and in the future. However, predicting future ratings of a product is a more complicated task than predicting how a reviewer would rate the product at present, since such a prediction should take into account products that may be released in the intervening time that may raise performance expectations for the product category. Such an implementation of the inventive system and methods would benefit from leveraging information obtained from a wider variety of sources, including product announcements, rumored updates, currently existing products, estimated trends in technology (e.g., features starting in high-end products but appearing in midrange and lower end products over time), etc.

In one embodiment, a predictive sentiment analysis system may be implemented in a way that is similar to how the inventive system for predicting future aggregate ratings described herein is structured. For example, based on an existing system for performing sentiment analysis, product features and time-stamped reviews for products may be introduced to provide a system that generates a training data set, where each record in the data set represents a particular product at a particular point in time. Within the data set, a product may have several records, each corresponding to a different point in the product's lifecycle. Each record may have several prediction “targets”, with each target corresponding to an aggregate opinion or evaluation of a particular aspect of a product, as found from future reviews with respect to the time-stamp of the record. The “future opinions” may be generated by running the sentiment analysis system on reviews that occur after the time-stamp of the record in question.

Prediction features may be generated from information that is available in the past with respect to the time-stamp of the record. This includes information that can be gleaned from reviews such as sentiments, product rating, volume of reviews, or other review aggregates. Other potential features include pricing and/or technical specifications.

Predictions regarding future aggregate sentiments may be obtained via a regression algorithm, in which case the goal is to predict the aggregate sentiment value generated by the analysis system based on future reviews. Such a system can be implemented via several types of models, including but not limited to decision trees, support vector machines, neural networks, Gaussian processes, non-parametric models (e.g., nearest neighbors or Parzen's windows), generalized linear models, or ensembles of one or more of the models mentioned. The algorithm(s) can be trained via a variety of approaches, including gradient descent, gradient boosted trees, random forests, support vector classification, or similar algorithms.

As an alternative, instead of predicting the overall future aggregate sentiment for a product, an investigator may try to determine a rank from the target sentiments, and then predict the future rank of a product with respect to specific sentiments. In this case, various learning algorithms that are specialized for ranking may be used, such as support vector machines, neural networks, or decision tree ensembles that are optimized for ranking metrics. Examples of such algorithms are lambdarank, lambdamart, and NDCGBoost.

Instead of predicting an overall future aggregate sentiment, the inventive system and methods may be used to predict the probability that a future customer will have a positive opinion (as opposed to a negative opinion) with regards to a particular aspect of a product. This can be done by viewing the task as a classification problem and using a classification algorithm to train a machine learning model. Decision trees, decision tree ensembles, Bayesian networks, support vector machines, generalized linear models, and neural networks may be used for classification, with the appropriate optimization criteria. Examples of specific algorithms that may be used include support vector classifiers, logistic regression, gradient boosted trees trained to optimize log loss, and naïve Bayes. In order to turn the sentiment prediction problem into a classification problem, an investigator can turn the target rating into a “Positive” or a “Negative” target. This can be done by randomly assigning the label, with a probability proportional to the percentage of review sentiments that correspond with that polarity. Another option would be to create both a “Positive” and a “Negative” labeled example for each record, but associate a weight with each example that is in proportion to the percentage of sentiments that are expressed with the corresponding polarity.

Note that these types of future predictions may apply to other ways of processing or interpreting data. For example, if embodiments of the inventive system and methods can predict how many complaints relating to reliability that the products from a given manufacturer will receive in the next 6 months (with a desired confidence level), then consumers can make a more informed choice of what product to purchase.

Visual Display of Data Generated by Embodiments of the Invention

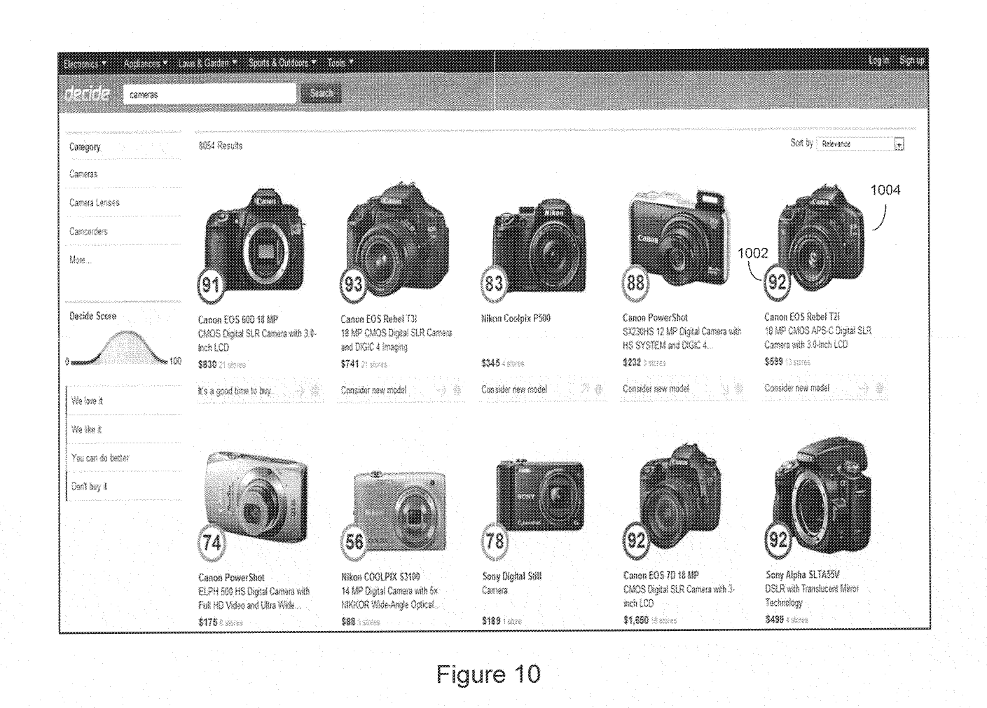

FIGS. 10-13 are illustrative “screen shots” or displays, showing how features of an embodiment of the invention may be presented to a consumer. Referring to FIG. 10, in one embodiment of the inventive system and methods, a combined aggregate review (CAR) score or predictive rating 1002 for a base product 1004 is associated with the base product's variants and presented to consumers via a searchable website. The website (such as that depicted in FIG. 10) may display search results and the associated overall product rating for each illustrated product. The search results may be provided with certain functionality based on the generated product rating, including the ability to rank results by the product rating or filter products by ratings (e.g., only the relatively more highly rated products are shown).

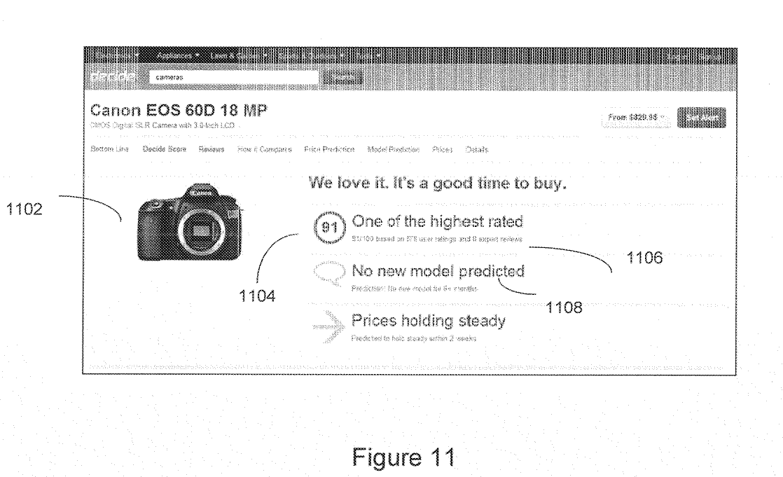

Referring to FIG. 11, the product's 1102 page may display the overall rating 1104, along with a summary of the data used to calculate the rating 1106, such as the number of user and expert reviews that were analyzed, along with reasons for the rating. Other predictive content may also be displayed to aid in the consumer's purchasing decision. For example, the digital camera shown in FIG. 11 has a relatively high rating and is a recommended purchase; in addition, present information does not suggest that a newer model will become available in the near term 1108.

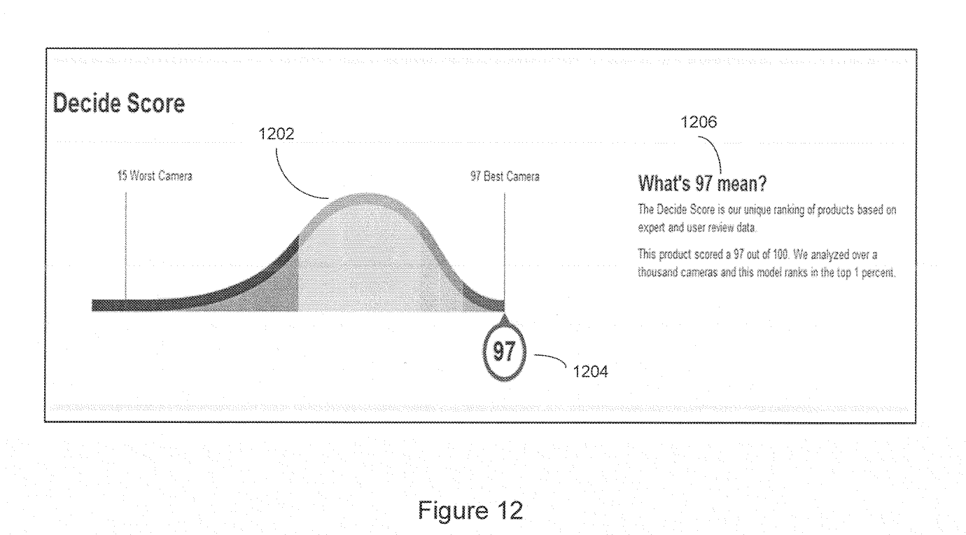

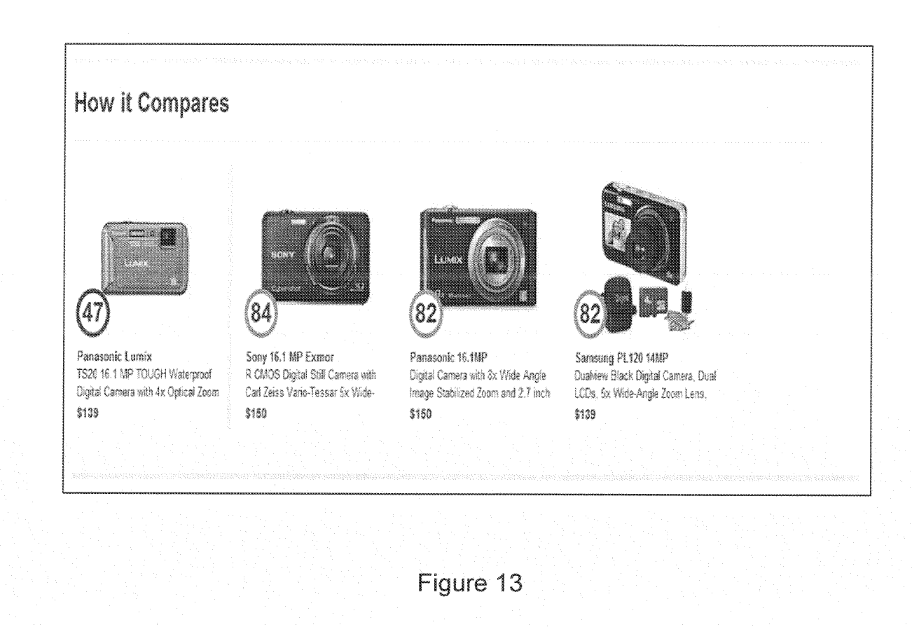

Referring to FIG. 12, for each product variant, the consumer may view a distribution graph 1202 that shows where the product's rating or score 1204 falls within the distribution of rated products within the same product category, in this case digital cameras. The consumer may also be provided with a summary of the meaning of the product's rating or score 1206. Referring to FIG. 13, in one embodiment, similar products from within the same product category (as a product of interest to a consumer) may be presented as alternatives, along with their associated ratings or scores.

If a product has a limited number of reviews (e.g., the data is sparse because it was recently released or is scheduled to be released in the future), then there may not be enough underlying review data to generate a reliable score for the product. In accordance with one embodiment of the inventive system and methods, the model histories for previous models of the same product (and if desired, for other products in the same base product cluster and product category) may be used to generate a predicted score. As reviews become available for the product, these can be incorporated into the score. For example, if digital cameras A and B were highly rated cameras made by a company with a reputation for producing highly rated products in general, then this information can be used to predict a high likelihood that a new model C will also be a highly-rated camera.

As mentioned, in addition to providing a score or rating for a product, it may also be desirable to provide an explanation of how the score was determined (as illustrated by element 1206 of FIG. 12). In order to generate this explanation, in one embodiment the following process may be used:

(1) Generate a set of statistical quantities about the product such as (# user reviews, # expert reviews, # recent reviews, average expert/user score, variance of the score, product age, etc.);

(2) Pre-generate a list of potential test conditions based on the generated score, product statistics, and average statistics of the product as a whole; and

(3) Based on which test conditions the product matches, generate a template explanation for why the product was rated as such.

The elements, components, processes, methods, functions, and operations described with reference to one or more embodiments of the invention can be utilized in multiple ways to assist in generating “predictions” with regards to the expected rating or ranking of a product or service. These predictions can then be used to inform consumers which products or services are expected to be reliable, good values, etc. By using one or more machine learning models that are trained using product data and product review data, embodiments of the invention are able to generate predictions of expected ratings behavior for new products and/or similar products. Further, when the product data and product review data is associated with a time at which the data was generated or became valid, embodiments of the invention are able to predict how a product or a product's features will be viewed in the future.

For example, a system may be created to predict the expected average review rating and expected number of reviews of a product. This information may then be displayed on a website or provided for internal usage by a marketing agency, sales channel, or manufacturer. FIG. 14 is a flow chart or flow diagram illustrating an exemplary process for generating expected review ratings and the quantity of such reviews, which may be implemented using the inventive processes and methods described herein. As shown in the figure, product review and product related data may be gathered by a suitable data collection process (stage 1401). Products may then be associated and placed into variant clusters (stage 1402), as described herein with reference to FIG. 7. The gathered review data may be matched or associated with specific products or variant clusters (stage 1403), as described herein with reference to FIG. 6. A training dataset may be created by generating training features for each product at different points in time (stage 1404), as described herein with reference to the processes for predicting future review aggregates. Targets for the training dataset (stage 1405) may be generated using standard aggregation processes (e.g., count, average) of product data, based on reviews that happen in the future with respect to the same points in time. Alternately, the targets may be generated based on a process for creating combined review ratings, such as by using one or more of the formulas described herein with reference to processes for combining user and/or expert reviews. In addition, one or more of the processes described with reference to FIG. 8 may also be used in a method for generating aggregates of past user/expert reviews for the purpose of providing training features. A prediction model may be generated based on the combined training data (stage 1406). Features for scoring products based on the models may be generated (stage 1407) in the same manner as the training features (except for being based on additional available data for a product). A prediction may then be generated for the product (stage 1408).

A predictive system/processes of the form shown in FIG. 14 may also be used to generate a component that is used in an aggregate rating system (such as that illustrated in FIG. 8). For example, one or more of the quantities or parameters such as ANM, ANSD, S_{U,C}, or NS may be generated by a predictive model.

Further, a system/processes of the form shown in FIG. 14 may also be used to predict sentiments that future customers may hold about a product if the target function generation (stage 1405) uses a sentiment analysis algorithm that operates over reviews that are written in the future with respect to the time-stamp of a training record.

As described herein, features that are potentially relevant to future customer response towards a product (e.g., as exemplified by future sales or reviews), including but not limited to data about the product (such as past sales numbers, reviews, or ratings), data about similar products (such as other variants of the same base product or of a similar product), data about a group of products, or data about the manufacturer of a product (such as reliability, consumer acceptance, reputation data, etc.) may be processed/computed for multiple products at different points in time in the past. The processed/computed data may be used as an input to a machine learning process (e.g., a suitable algorithm or system) in order to produce a “model” that can be used to generate a “prediction” of some information about (or characteristic of) another product for which the same (or an equivalent) set of features may be obtained in whole or in part.

For example, data or information such as sales numbers, product features, technical specifications, reviews, historical manufacturer quality for the same or similar models, etc. may be processed/computed for multiple products at multiple points in each product's history. This data may be used as “training” data for a machine learning system or process. As noted, the products included in the training data may relate to the product in question (the one for which a prediction of a characteristic is desired), to a similar product from the same manufacturer, to a prior variant of the same base product, to substantially equivalent products in the same general product group, or to another relevant product or products. However, note that there is no requirement that products included in the training data have a particular relationship to the product in question. As a specific example, training data may comprise information known about every single product in a product catalog, with a unique training record for every product on every date when it was available for sale up until the present. This may mean that a television that was released 365 days ago, has 365 separate training records represented in the training dataset, where each training record comprises different feature values (according to review information or other time sensitive information published or known about the product at that time).

When at least some of the product/training data may be segmented into data known or generated before different points in time and into data generated after those points in time (such as based on when it was published or when the product to which it relates was made available for sale), then data having a time prior to a set time (i.e., the observation time) may be used to train a machine learning model to “predict” a target value (representing some score, such as a product rating, or a characteristic such as a consumer sentiment) of the product that would be present at a later time. In this way the time-referenced data may be used to drive an adaptive process which converges on an actual value of data from a time later than the set time. One output of this process is a rule, function, relationship, or algorithm that represents a “model” of how the characteristic (such as product rating, sales, etc.) varies over time with respect to one or more types of input data (e.g., sales, ratings, rankings, a certain consumer sentiment, etc.).

The resulting “model” may then be used to generate a “prediction” of how a characteristic of a product (e.g., rating, ranking, sales, etc.) will behave in the future. Note that this prediction is based on access to information/data for the characteristic or product which may be processed into data of the form used in training the model (i.e., data of the type found in the training records). For example, a machine learning model may be developed that uses past reviews for a product (A) and the overall rating for past products in the same model series as (A) to predict a quantity related to future reviews for the product (A). Such a machine learning model might be trained on a dataset where each record in the dataset contains information about a single product (P) at a time (t). In such a case, the record may comprise past reviews of (P) with respect to (t), overall reviews for past products in the same model series as (P) that are known at time (t), and an associated “target” computed from future reviews for (P) with respect to time (t). A predictive model trained on this dataset may be used to generate a prediction of the future reviews (or a related quantity) for a different product (Q), where one knows or can compute some subset of (1) past reviews for (Q) and (2) aggregate reviews for older products in the same model series as (Q). However, note that (P) and (Q) do not need to have a direct relationship (e.g., that of being the same brand, the same model series, or even the same product category) for this methodology to be used.

The inventive system, apparatuses, and methods may be used to provide a consumer with an expected product rating and/or consumer satisfaction level in the future based on the currently-known reviews or sales data for a relatively new product that is available. Similarly, the inventive system, apparatuses, and methods may be used to adjust a current product rating or review for a relatively new product so that the rating or review more closely reflects the expected (i.e., “predicted”) future consumer sentiment about the product (as expressed by expected sales, reviews, etc.). This may provide a consumer with a more realistic view of how a new product will be evaluated by purchasers after sufficient sales, ratings, or reviews become available.

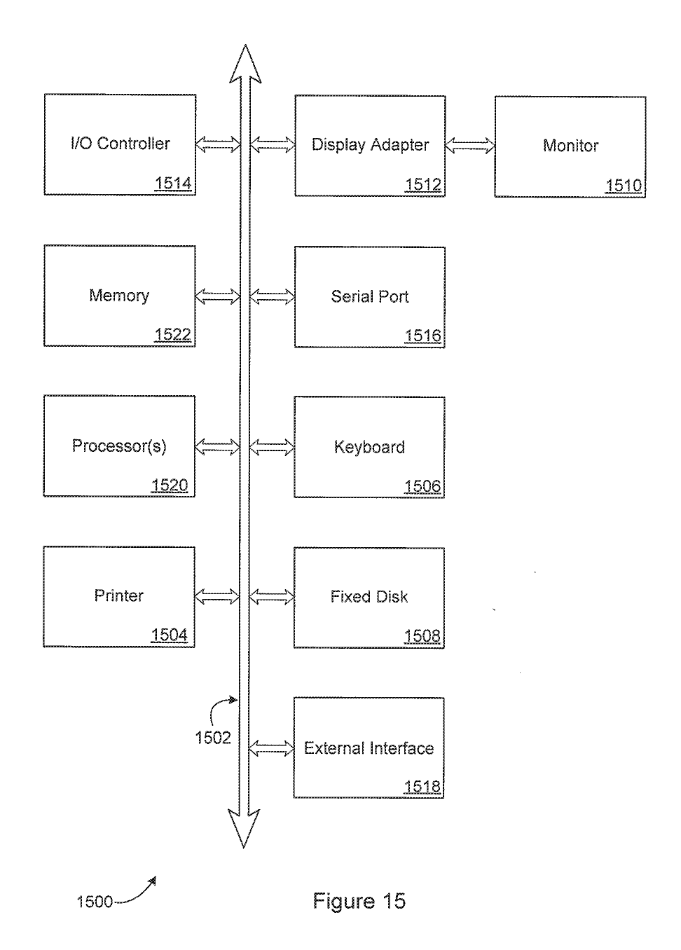

In accordance with one or more embodiments of the invention, the system, apparatus, methods, processes, functions, and/or operations described herein for the aggregation or prediction of product or service ratings/rankings may be wholly or partially implemented in the form of a set of instructions executed by one or more programmed computer processors, such as a central processing unit (CPU), controller, processor, or microprocessor. Such computer processors may be incorporated in an apparatus, server, client or other computing device operated by, or in communication with, other components of the system. As an example, FIG. 15 is a block diagram illustrating example elements or components of a computing device or system 1500 that may be used to implement one or more of the methods, processes, functions or operations of an embodiment of the invention. The subsystems shown in FIG. 15 are interconnected via a system bus 1502. Additional subsystems include a printer 1504, a keyboard 1506, a fixed disk 1508, and a monitor 1510, which is coupled to a display adapter 1512. Peripherals and input/output (I/O) devices, which couple to an I/O controller 1514, can be connected to the computer system by any number of means known in the art, such as a universal serial bus (USB) port 1516. For example, the USB port 1516 or an external interface 1518 can be utilized to connect the computer device 1500 to further devices and/or systems not shown in FIG. 15 including a wide area network such as the Internet, a mouse input device, and/or a scanner. The interconnection via the system bus 1502 allows one or more processors 1520 to communicate with each subsystem and to control the execution of instructions that may be stored in a system memory 1522 and/or the fixed disk 1508, as well as the exchange of information between subsystems. The system memory 1522 and/or the fixed disk 1508 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software. Embodiments of the invention may be implemented using hardware, software, or a combination of hardware and software. Embodiments or aspects may be implemented using a dedicated device (such as an application specific integrated circuit) or a programmable device (such as a gate array or programmed CPU).

Any of the software components, elements, operations, processes or functions described herein may be implemented as software code to be executed by a processor using any suitable computer language such as, for example, Java, C++, or Perl, using, for example, conventional or object-oriented techniques. The software code may be stored as a series of instructions, or commands on a computer readable medium, such as a random access memory (RAM) a read-only memory (ROM), a magnetic medium such as a hard-drive, a solid-state device such as a flash memory drive, or an optical medium such as a CD-ROM. Any such computer readable medium may reside on or within a single computation al apparatus, and may be present on or within different computational apparatuses within a system or network.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A method of generating a rating for a product or service, comprising:
accessing data relevant to the product or service;
associating at least some portion of the accessed data with a time or date at which the data was valid;
using accessed data applicable to a first time or date as training data that is input to a machine learning process, where accessed data applicable to a second and later time or date is used as a target for the machine learning process, a result of the machine learning process being a model representing a relationship between the accessed data applicable at the first time or date and the accessed data applicable at the second time or date; and
using the model to generate the rating for the product or service by
using data for the product or service as an input to the model;
using the model to generate an output of the model; and
deriving the rating for the product or service from the output of the model.
